(19) United States
(12) Patent Application Publication
(10) Pub. No.: US 2025/0285539 A1
(43) Pub. Date: Sep. 11, 2025

(54) ELECTRONIC DEVICE AND METHOD FOR TRANSMITTING DATA TO PLATOONING VEHICLE

(71) Applicant: THINKWARE CORPORATION, Seongnam-si (KR)

(72) Inventors: Haejun JUNG, Seongnam-si (KR); Dongwon SHIN, Seongnam-si (KR)

(21) Appl. No.: 19/074,274

(22) Filed: Mar. 7, 2025

(30) Foreign Application Priority Data
Mar. 8, 2024 (KR) 10-2024-0033494

(51) Int. Cl. G08G 1/0967; G06V 10/75; G06V 10/764; G06V 10/82; G06V 20/56; G08G 1/00

(52) U.S. Cl. CPC G08G 1/096725; G06V 10/751; G06V 10/764; G06V 10/82; G06V 20/588; G08G 1/096791; G08G 1/22

(57) ABSTRACT

An electronic device may obtain an image through a camera. The electronic device may identify, using the image and a neural network model, a first classification result of an object included in the image. The electronic device may transmit, through communication circuitry, to external electronic devices included in vehicles subsequent to a vehicle equipped with the electronic device, a feature map of the neural network model based on the image. The electronic device may obtain, through the communication circuitry, from the external electronic devices, second classification results of the object which are calculated based on the feature map by the external electronic devices. The electronic device may determine, based on the first classification result and the second classification results, whether to drive the vehicle as a preceding vehicle.

### CROSS-REFERENCE TO RELATED APPLICATION(S)

This application is based on and claims priority to Korean Patent Application No. 10-2024-0033494, filed on Mar. 8, 2024, in the Korean Intellectual Property Office, the disclosure of which is incorporated by reference herein its entirety.

### BACKGROUND

### Field

The disclosure relates to an electronic device and method for transmitting data to a platooning vehicle.

### Description of Related Art

In general, platooning means that multiple vehicles drive on the road while sharing driving information with each other. Platooning vehicles may drive in a certain formation. Platooning may enhance fuel efficiency by reducing inter-vehicle gaps and hence air resistance, reducing the risk of accidents, and reducing traffic congestion by controlling the flow of vehicles. Platooning vehicles may include a leading vehicle and following vehicles. An electronic device equipped to the leading vehicle may control platooning. For example, the electronic device may identify external objects in front of the leading vehicle, set up a driving route based on the external objects, and control the speed and direction of the vehicles.

The above-described information may be provided as related art for the purpose of helping understanding of the disclosure. No claim or determination is made as to whether any of the foregoing is applicable as background art in relation to the disclosure.

### SUMMARY

An electronic device may comprise a camera, communication circuitry, memory storing a neural network model and instructions, and a processor operably coupled to the camera, the communication circuitry, and the memory. The instructions may, when executed by the processor, cause the electronic device to obtain, through the camera, an image. The instructions may, when executed by the processor, cause the electronic device to identify, using the image and the neural network model, a first classification result of an object included in the image. The instructions may, when executed by the processor, cause the electronic device to transmit, through the communication circuitry, to external electronic devices included in vehicles subsequent to a vehicle equipped with the electronic device, a feature map of the neural network model based on the image. The instructions may, when executed by the processor, cause the electronic device to obtain, through the communication circuitry, from the external electronic devices, second classification results of the object which are calculated based on the feature map by the external electronic devices. The instructions may, when executed by the processor, cause the electronic device to determine, based on the first classification result and the second classification results, whether to drive the vehicle as a preceding vehicle.

An electronic device may comprise a camera, communication circuitry, memory storing a neural network model and instructions, and a processor operably coupled to the camera, the communication circuitry, and the memory. The instructions may, when executed by the processor, cause the electronic device to obtain, through the camera, an image. The instructions may, when executed by the processor, cause the electronic device to identify, using the image and the neural network model, an area where a preceding vehicle is included in the image. The instructions may, when executed by the processor, cause the electronic device to transmit, through the communication circuitry, to external electronic devices included in vehicles subsequent to a vehicle equipped with the electronic device, remaining areas other than the area in the image.

A method may be performed by an electronic device including a camera and communication circuitry. The method may comprise obtaining, through the camera, an image. The method may comprise identifying, using the image and a neural network model, a first classification result of an object included in the image. The method may comprise transmitting, through the communication circuitry, to external electronic devices included in vehicles subsequent to a vehicle equipped with the electronic device, a feature map of the neural network model based on the image. The method may comprise obtaining, through the communication circuitry, from the external electronic devices, second classification results of the object which are calculated based on the feature map by the external electronic devices. The method may comprise determining, based on the first classification result and the second classification results, whether to drive the vehicle as a preceding vehicle.

A method may be performed by an electronic device including a camera and communication circuitry. The method may comprise obtaining, through the camera, an image. The method may comprise identifying an area where a preceding vehicle is included in the image using the image and a neural network model. The method may comprise transmitting, through the communication circuitry, to external electronic devices included in vehicles subsequent to the vehicle equipped with the electronic device, remaining areas other than the area in the image.

A non-transitory, computer-readable storage medium may store one or more programs. The one or more programs may, when executed by a processor of an electronic device having a camera and communication circuitry, cause the electronic device to obtain an image through the camera. The instructions may, when executed by the processor, cause the electronic device to identify, using the image and the neural network model, a first classification result of an object included in the image. The instructions may, when executed by the processor, cause the electronic device to transmit, through the communication circuitry, to external electronic devices included in vehicles subsequent to a vehicle equipped with the electronic device, a feature map of the neural network model based on the image. The instructions may, when executed by the processor, cause the electronic device to obtain, through the communication circuitry, from the external electronic devices, second classification results of the object which are calculated based on the feature map by the external electronic devices. The instructions may, when executed by the processor, cause the electronic device to determine, based on the first classification result and the second classification results, whether to drive the vehicle as a preceding vehicle.

A non-transitory, computer-readable recording medium may store one or more programs. The one or more programs may, when executed by a processor of an electronic device having a camera and communication circuitry, cause the electronic device to obtain an image through the camera. The instructions may, when executed by the processor, cause the electronic device to identify, using the image and the neural network model, an area where a preceding vehicle is included in the image. The instructions may, when executed by the processor, cause the electronic device to transmit, through the communication circuitry, to external electronic devices included in vehicles subsequent to a vehicle equipped with the electronic device, remaining areas other than the area in the image.

According to an embodiment, the electronic device and method by the same may reduce resources required for data exchange between platooning vehicles.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating electronic devices for platooning of vehicles according to an embodiment;

FIG. 2 schematically illustrates platooning vehicles having electronic devices according to an embodiment;

FIG. 3 illustrates a front image according to an embodiment;

FIG. 4 illustrates a neural network for generating a feature map according to an embodiment;

FIG. 5 schematically illustrates platooning vehicles with a leading vehicle changed according to an embodiment;

FIG. 6A schematically illustrates a circumstance in which a following vehicle identifies a hazard while platooning according to an embodiment;

FIG. 6B illustrates a front image according to an embodiment;

FIG. 7 illustrates an example of an area to be transferred to a following vehicle in a front image according to an embodiment;

FIG. 8 illustrates an example of a method for calculating a width of an object in a front image according to an embodiment;

FIG. 9 illustrates an example of a method for calculating a size of an object according to an embodiment;

FIG. 10 is a flowchart illustrating an operation method of an electronic device according to an embodiment;

FIG. 11 is a flowchart illustrating an operation method of an electronic device according to an embodiment;

FIG. 12 is a block diagram illustrating an example of an autonomous driving system of a vehicle according to an embodiment;

FIGS. 13 and 14 are block diagrams illustrating an example of an autonomous driving moving object according to an embodiment;

FIG. 15 illustrates an example of a gateway related to a user device according to various embodiments;

FIG. 16 is a view illustrating operations of an electronic device training a neural network based on a set of training data according to an embodiment;

FIG. 17 is a block diagram illustrating an electronic device according to an embodiment;

FIG. 18 is a view illustrating a state in which a tractor and a trailer are not connected; and

FIG. 19 is a view illustrating a state in which a tractor and a trailer are connected.

### DETAILED DESCRIPTION

Hereinafter, embodiments of the disclosure are described with reference to the accompanying drawings. With regard to the description of the drawings, similar reference numerals may be used to refer to similar or related elements.

Throughout the years, the trucking industry experienced steady growth and expanded the reach of its services to respond to more complex supply chains. These services include last-mile deliveries, drop-trailer programs, and intermodal transportation at ports (in which freight is carried to the destination by two or more different means of transportation (ship and rail, ship and airplane).

As such, because the methods of transporting freight are very diverse, manufacturers of freight-related equipment have designed different types of equipment to transport freight according to various transportation needs.

In the disclosure, a truck that tows a trailer for the main purpose of freight carrying or catering is collectively referred to as a tractor.

Tractors described in the disclosure may be classified into conventional trucks (or bonneted trucks), cab-over trucks (or cab-over engines), and semi-conventional trucks, which are intermediate forms of conventional trucks and cab-over trucks, depending on the location and shape of the tractor's cab.

The conventional truck has a structure in which the engine and the hood are positioned on the front axle of the tractor's cap, allowing the driver to sit behind the front axle, and is a type of tractor mainly used in North America where the tractor's engine is positioned in front of the driver.

On the other hand, the cap-over truck has a structure in which the cap of the tractor is positioned to the front end of the tractor, allowing the driver to sit in front of the front axle, and the front of the tractor is in the form of a so-called “flat face (or flat nose)” where the tractor's engine is positioned below the driver, which is a type of tractor mainly used in most countries such as Europe and Asia.

Just as there are various forms depending on the purpose and demand of a tractor, there are various forms of trailers towed by tractors. Among them, the most representative types of trailers are full-trailers and semi-trailers. The full-trailer and the semi-trailer may be distinguished by whether the trailer is equipped with both front and rear axles. Such a trailer may be connected to a box truck or a tractor through a coupling device.

Specifically, the full-trailer is a commercial freight trailer equipped with both front and rear axles. The full-trailer is designed to support the total load only with the trailer, so that it may fully support its weight without relying on a tractor, and is equipped with a drawbar to be coupled with a hauling unit (or towing unit) such as a tractor, and is mainly in the United States and Canada.

On the other hand, the semi-trailer is a freight trailer equipped with only a rear axle without a front axle, and supports a large portion of the load by a tractor connected by a type of hitch called a “fifth wheel.” When the semi-trailer is detected from the tractor and becomes stationary, the load of the trailer may be supported by spreading the landing gear mounted on the lower portion of the semi-trailer perpendicularly to the ground. A combination of a semi-trailer and a tractor is referred to as a “semi-trailer truck” (in the U.S., simply referred to as a “semi-trailer,”, a “tractor-trailer,” a “semi-truck,” a “big rig,” or a “semi”). The above-described “fifth wheel” refers to a horizontal wheel attached to the tractor axle of the trailer truck to facilitate the direction change of the trailer. The “fifth wheel” is a device that allows the tractor and the semi-trailer to be operably coupled to each other and typically includes a lower portion constituted of a hitch device and a trunnion plate for securing the kingpin mounted on the semi-trailer to the tractor.

Hereinafter, in the disclosure, based on the terms of the tractors/trailers described above, “trailer” is used as referring to a freight transportation vehicle connected to a tractor for a trailer, and “trailer” is used as referring to a towing vehicle for moving the trailer for convenience of description. Further, in the disclosure, in order to exclude the limitation of rights according to the embodiments described in the detailed description as much as possible, a tractor that hauls/tows a “trailer” may be described interchangeably with “towing vehicle” and a trailer towed by a tractor may be described interchangeably with “towed vehicle.”

Further, for convenience of description, it is preferable to understand that the “trailer” described throughout the specification refers to a “semi-trailer,” but is not limited thereto.

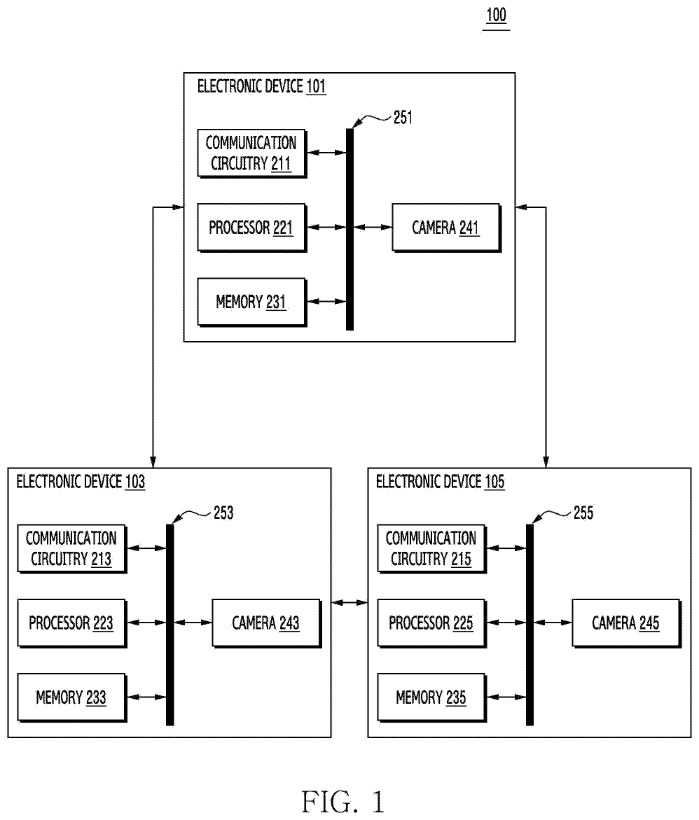

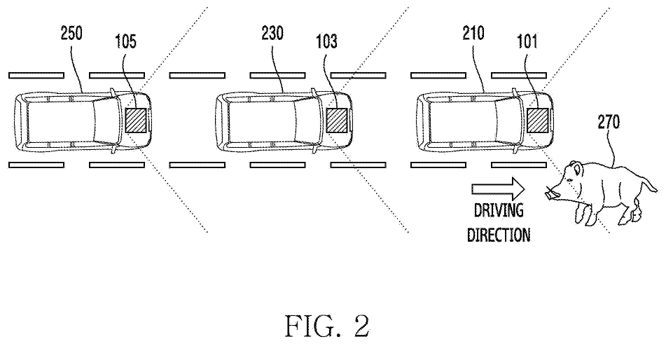

FIG. 1 is a block diagram illustrating electronic devices for platooning of vehicles according to an embodiment. FIG. 2 schematically illustrates platooning vehicles having electronic devices according to an embodiment.

Referring to FIG. 1, an electronic device 101 according to an embodiment may include communication circuitry 211, a processor 221, memory 231, and/or a camera 241. According to an embodiment, the electronic device 101 may include a global positioning system (GPS) sensor.

In an embodiment, the electronic device 101 may correspond to, or be included in, an electronic controller (ECU) in the vehicle. The ECU may be referred to as an electronic control module (ECM). The electronic device 101 may be configured as a piece of independent hardware for the purpose of providing functions according to an embodiment of the disclosure in a vehicle. Embodiments are not limited thereto, and the electronic device 101 may correspond to, or be included in, a device (e.g., a black box) attached to the vehicle. In an embodiment, the electronic device 101 may be referred to as an electronic device disposed in a leading vehicle (e.g., the vehicle 210 of FIG. 2).

For example, the processor 221, the memory 231, the communication circuitry 211, and/or the camera 241 may be electrically and/or operatively connected to each other by an electronic component such as a communication bus 251. Hereinafter, “pieces of hardware are operatively coupled” may mean that a direct or indirect connection between the pieces of hardware is established wiredly or wirelessly so that a second piece of hardware is controlled by a first piece of hardware among the pieces of hardware. Hereinafter, “pieces of hardware are operatively coupled” may mean that a direct or indirect connection between the pieces of hardware is established wiredly or wirelessly so that a second piece of hardware is controlled by a first piece of hardware among the pieces of hardware. Although different blocks are illustrated, embodiments are not limited thereto. Some of the pieces of hardware of FIG. 1 may be included in a single integrated circuit such as a system on chip (SoC). The type and/or number of the pieces of hardware included in the electronic device 101 is not limited as illustrated in FIG. 1. For example, the electronic device 101 may include only some of the pieces of hardware illustrated in FIG. 1.

According to an embodiment, the communication circuitry 211 of the electronic device 101 may include hardware components for transmitting and/or receiving electric signals between the electronic device 101 and external electronic devices 103 and 105. The communication circuitry 211 may include at least one of, e.g., a modem, an antenna, and an optic/electronic (O/E) converter. The communication circuitry 211 may support transmission and/or reception of electric signals based on various types of protocols such as Ethernet, local area network (LAN), wide area network (WAN), wireless fidelity (Wi-Fi), Bluetooth, Bluetooth low energy (BLE), ZigBee, long term evolution (LTE), 5G new radio (NR), non-terrestrial network, and/or 6G.

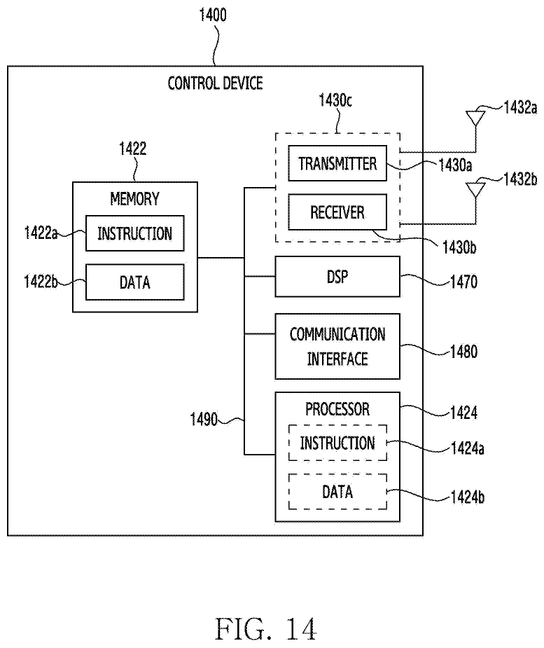

According to an embodiment, the communication circuitry 211 may be used for wireless communication with external electronic devices 103 and 105. For example, the electronic device 101 may be configured to wirelessly communicate with the external electronic devices 103 and 105 and/or other external electronic devices (e.g., a base station and/or a satellite) using the communication circuitry 211. The communication circuitry 211 may be electrically connected to an antenna (e.g., the antenna 1432a or 1432b of FIG. 14) for transmitting and/or receiving a signal. The communication circuitry 211 may convert an analog signal provided from the processor 221 into a digital signal and upconvert a baseband signal into a radio frequency (RF) signal. The electronic device 101 may obtain information related to the real-time position of the platoon using the GPS sensor 150 and transmit data including the information to the external electronic devices 103 and 105 using the communication circuitry 211. The electronic device 101 may transmit signals for controlling driving of the following vehicles (e.g., the vehicles 230 and 250 of FIG. 2) to the communication circuits 213 and 215 of the external electronic devices 103 and 105. The external electronic devices 103 and 105 may receive the signals through the communication circuits 213 and 215.

According to an embodiment, the electronic device 101 may include hardware for processing data based on one or more instructions. The hardware for processing the data may include a processor 120. For example, the hardware for processing the data may include an arithmetic and logic unit (ALU), a floating point unit (FPU), a field programmable gate array (FPGA), a central processing unit (CPU), and/or an application processor (AP). The processor 120 may have a structure of a single-core processor or a structure of a multi-core processor such as a dual core, a quad core, a hexa core, or an octa core.

According to an embodiment, the memory 231 may include a hardware component for storing data and/or instructions executable by the processor 221. The memory 231 may include, e.g., volatile memory such as random-access memory (RAM), and/or non-volatile memory such as read-only memory (ROM). For example, the volatile memory may include, e.g., at least one of dynamic RAM (DRAM), static RAM (SRAM), cache RAM, and pseudo SRAM (PSRAM). For example, the non-volatile memory may include at least one of, e.g., programmable ROM (PROM), erasable PROM (EPROM), electrically erasable PROM (EEPROM), flash memory, hard disk, compact disk, solid state drive (SSD), and embedded multi-media card (eMMC).

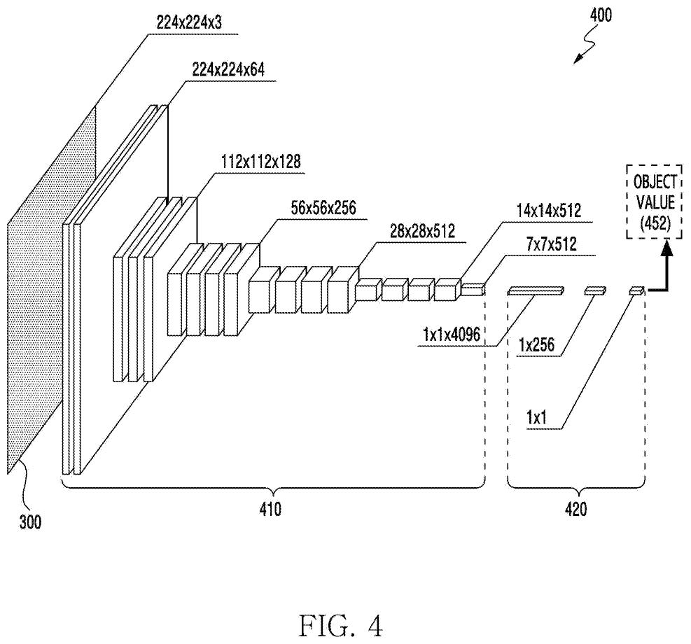

In an embodiment, the memory 231 of the electronic device 101 may include an image processing model (e.g., a neural network model) (e.g., the neural network model 400 of FIG. 4). The electronic device 101 may identify an external object 270 based on the image processing model (e.g., a neural network model) stored in the memory 231. Hereinafter, the image processing model may be referred to as a neural network model 400. In an embodiment, the neural network model 400 may include a mathematical model of neural activity of a living organism related to reasoning and/or cognition and/or hardware for driving the mathematical model (e.g., a CPU, a graphic processing unit (GPU) and/or a neural processing unit (NPU)), software or a combination thereof. The neural network model 400 may be based on a convolutional neural network (CNN) and/or a long-short term memory (LSTM). However, the disclosure is not limited thereto. The neural network model 400 may include at least one of a generative adversarial networks (GAN) model, a residual-network (RESnet) model, a nonlinear-activation-free network (NAFnet) model or a text-prior-based super-resolution model.

According to an embodiment, the camera 241 may include a lens assembly or an image sensor. The lens assembly may collect light emitted or reflected from an object whose image is to be taken. The lens assembly may include one or more lenses. For example, the camera 241 may include a plurality of lens assemblies. For example, some of the plurality of lens assemblies of the camera 241 may have the same lens attribute (e.g., field of view, focal length, auto-focusing, f number, or optical zoom), or at least one lens assembly may have one or more lens attributes different from those of another lens assembly. The lens assembly may include a wide-angle lens or a telephoto lens. For example, the electronic device 101 may include a flash for the camera 241. The flash may include one or more light emitting diodes (LEDs) (e.g., a red-green-blue (RGB) LED, a white LED, an infrared (IR) LED, or an ultraviolet (UV) LED) or a xenon lamp. For example, the image sensor may obtain an image corresponding to an object by converting light emitted or reflected from the object and transmitted via the lens assembly into an electrical signal. According to an embodiment, the image sensor may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor may be implemented using, e.g., a charged coupled device (CCD) sensor or a complementary metal oxide semiconductor (CMOS) sensor.

According to an embodiment, the camera 241 may be positioned (or disposed) in one direction of the vehicle 210. FIG. 2 illustrates that the electronic device 101 (or the camera 241 included in the electronic device 101) is disposed in the front direction and/or driving direction of the vehicle 210, but the disclosure is not limited thereto. For example, the camera 241 of the electronic device 101 may be positioned in at least one of the rear direction or the side direction of the vehicle 210.

According to an embodiment, the electronic device 101 may identify the ambient environments of the leading vehicle (e.g., the vehicle 210) using the camera 241. For example, the electronic device 101 may identify an external object 270 based on an image obtained through the camera 241. For example, the electronic device 101 may identify the external object 270 corresponding to the image obtained through the camera 241 using the neural network model 400.

Each of the electronic devices 103 and 105 may include substantially the same components as the electronic device 101. For example, each of the electronic devices 103 and 105 may include a processor 223 or 225, memory 233 or 235, communication circuitry 213 or 215, a camera 243 or 245 and/or a communication bus 253 or 255. The descriptions of the components of the electronic device 101 may be substantially equally applied to the components of the electronic devices 103 and 105. For example, the memory 223 or 225 may include an image model.

In an embodiment, each of the electronic devices 103 and 105 may correspond to, or be included in, an ECU in the vehicle. In an embodiment, each of the electronic devices 103 and 105 may correspond to, or be included in, a device (e.g., a black box) attached to the vehicle. In an embodiment, each of the electronic devices 103 and 105 may be referred to as an electronic device disposed in following vehicles (e.g., the vehicles 230 and 250 of FIG. 2).

Referring to FIG. 2, two or more vehicles 210, 230, and 250 forming a platoon may drive while maintaining a designated formation. The vehicles 210, 230, and 250, respectively, may include electronic devices (e.g., the electronic devices 101, 103, and 105 of FIG. 1) for platooning. The electronic devices 101, 103, and 105 may share control information about the vehicles 210, 230, and 250 and information collected through the electronic devices 101, 103, and 105 respectively disposed in the vehicles 210, 230, and 250 in real-time using wireless communication technology. The wireless access technologies for exchanging information between the electronic devices 101, 103, and 105 may use various wireless access technologies, such as vehicle-to-infrastructure (V2I), vehicle-to-device (V2D), vehicle-to-vehicle (V2V), vehicle-to-pedestrian (V2P) or such vehicle-to-everything (V2X), cellular 5G new radio (NR) sidelink, 802-11-based dedicated short range communication (DSRC), or the like.

The vehicles 210, 230 and 250 may be divided into a leading vehicle and following vehicles. The leading vehicle may be referred to as a vehicle positioned in front among the platooning vehicles 210, 230, and 250, and the following vehicles may be referred to as the remaining vehicles other than the leading vehicle. The electronic device 101 disposed in the vehicle 210, which is the leading vehicle, may be used to control the overall operation of the platooning. For example, since the leading vehicle is positioned at the front of the platoon, the leading vehicle may include more electronic components (e.g., radio detection and ranging (RADAR), light detection and ranging (LIDAR), and camera) than the other following vehicles. However, the disclosure is not limited thereto.

The electronic device 101 may transmit and/or receive data to and/or from other electronic devices (e.g., base stations and/or satellites). For example, the electronic device 101 may receive data including information related to the driving route from an external electronic device to determine the driving route and transmit data including information related to the real-time position of the platoon to the external electronic device.

The electronic device 101 may be configured to control the driving of the vehicles 210, 230, and 250 based on information related to the platooning vehicles 210, 230, and 250 (e.g., driving route, driving speed, intervals between the vehicles 210, 230, and 250, and/or formation of the platoon) and/or information related to the ambient environment. For example, the electronic device 101 may transmit a signal for controlling platooning to each of the electronic devices 103 and 105 respectively disposed in the following vehicles 230 and 250. The electronic devices 103 and 105 may be configured to control driving of following vehicles (e.g., the vehicles 230 and 250) based on the signal received from the electronic device 101.

The information related to the ambient environment may include information related to the external object 270. For example, the external object 270 may be an object positioned around the driving route of the vehicles 210, 230, and 250, and may be an object that should be considered for safe driving. For example, the external object 270 may include, but is not limited to, other vehicles, lines, lanes, traffic lights, crosswalks, pedestrians, animals, and/or speed bumps.

According to an embodiment, since the electronic device 101 positioned in the vehicle 210, which is the leading vehicle, is positioned at the front in the platoon, the electronic device 101 may be configured to provide various functions. Further, since the electronic device 101 provides various functions, there may be a lot of information processed by the electronic device 101 and a lot of operations performed by the electronic device 101. For example, when an error occurs in identifying an external object from the front image obtained through the camera 241 as the electronic device 101 processes various pieces of information, the vehicles 210, 230, and 250 may have an accident. Therefore, a method may be required to change a vehicle with high accuracy in identifying an external object among the vehicles 210, 230, and 250 as the leading vehicle.

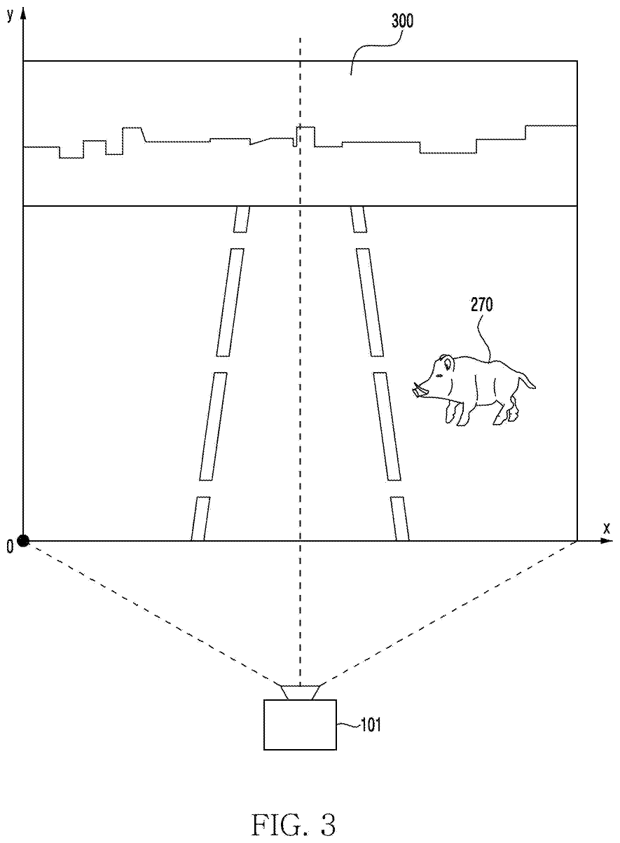

According to an embodiment, the vehicle 210, which is the leading vehicle, may transmit data including information related to the ambient environment to the vehicles 230 and 250. Accordingly, when only the classification result (or recognition result) of the neural network model 400 of the electronic device 101 of the leading vehicle and/or instructions (e.g., avoidance operation) according to the classification result (or recognition result) are transmitted to the electronic devices 103 and 105 of the following vehicles, it may be difficult to correct an error in the electronic device 101 of the preceding vehicle. Therefore, a method may be required to efficiently transfer information for independently identifying objects in the field of view of the preceding vehicle by following vehicles. Hereinafter, operations for changing a vehicle with high accuracy in identifying an external object among the vehicles 210, 230, and 250 as the leading vehicle may be described with reference to FIGS. 3 to 5.

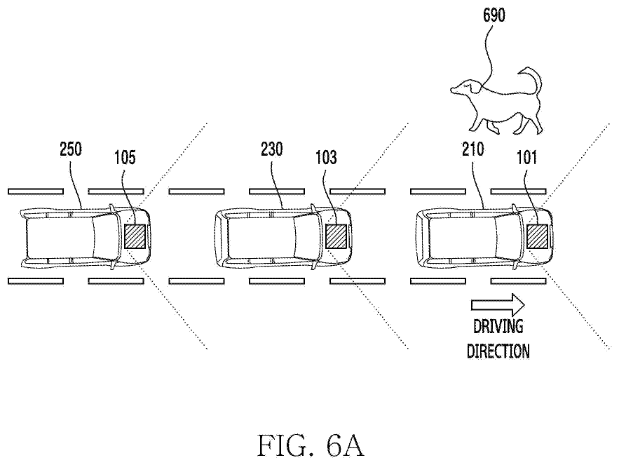

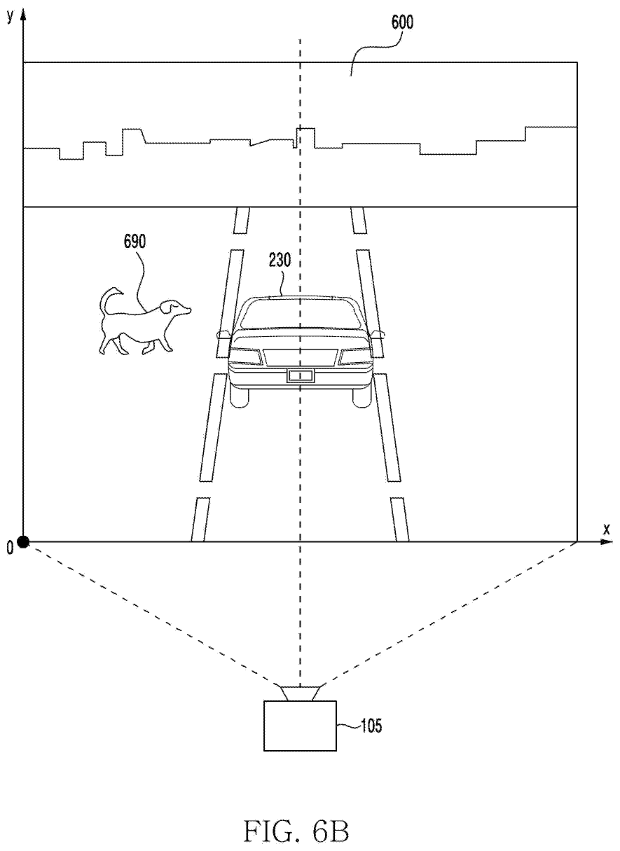

According to an embodiment, data including information related to the ambient environment may be transmitted/received between the electronic devices 101, 103, and 105. When the electronic devices 101, 103, and 105 sequentially transfer data including information related to the ambient environment to neighboring electronic devices, there may be a time difference in the transfer of information. Accordingly, a method may be required to preferentially share information related to the ambient environment obtained by the cameras 241, 243, and 245 included in the electronic devices 101, 103, and 105 to electronic devices requiring the information for, e.g., avoidance of external objects. Hereinafter, operations for preferentially transferring data including information related to the ambient environment may be described with reference to FIGS. 6A and 6B.

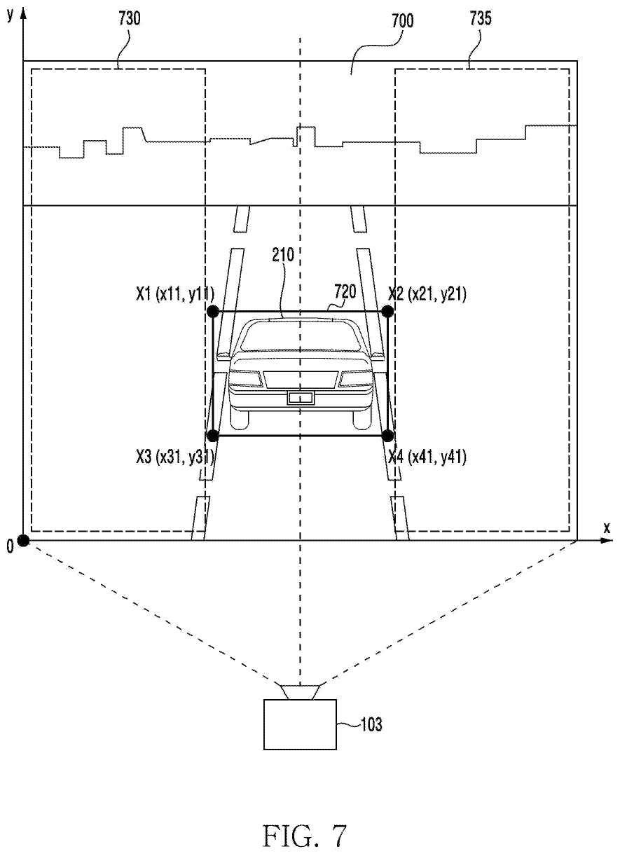

According to an embodiment, when the size of data including information related to the ambient environment is large, communication resources may increase between the electronic devices 101, 103, and 105. Accordingly, a method for efficiently reducing the size of data including information related to the ambient environment may be required. Hereinafter, operations for reducing data including information related to the ambient environment may be described with reference to FIG. 7.

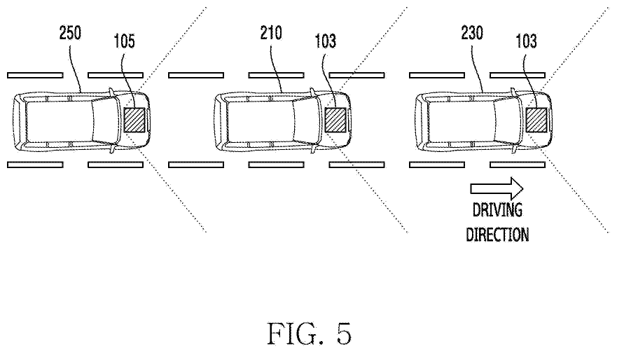

FIG. 3 illustrates a front image according to an embodiment. FIG. 4 illustrates a neural network for generating a feature map according to an embodiment. FIG. 5 schematically illustrates platooning vehicles with a leading vehicle changed according to an embodiment.

FIGS. 3 to 5 may be described with reference to FIGS. 1 and 2.

In an embodiment, referring to FIG. 3, the processor 221 may obtain an image 300 using the camera 241. According to an embodiment, the processor 221 of the electronic device 101 may obtain an image 300 for the outside of the vehicle 210 through the camera 241. The electronic device 101 may obtain an image 300 including an external object 270 in a field-of-view (FoV) of the camera 241 using the image 300 obtained through the camera.

According to an embodiment, referring to FIG. 4, the processor 221 may identify the object 270 and the type (or category) of the object 270 included in the image 300 using a designated neural network model (e.g., the neural network model 400 of FIG. 4).

For example, the designated neural network model 400 may be composed of a combination of a convolutional layer 410 and a fully connected (FC) layer 420. However, the disclosure is not limited thereto. In an embodiment, the processor 221 may identify a designated type of object (e.g., a vehicle, a traffic sign, or a road mark) through an image segmentation model and/or an object detection (OD) model in the image 300.

In an embodiment, the convolutional layers 410 may be used to maintain spatial information about the image 300 and extract features. In an embodiment, the FC layers 420 may be used to output data in a designated range. In an embodiment, the number of layers of the convolutional layers 410 may be, e.g., 13. In an embodiment, the number of layers of the FC layers 420 may be less than the number, e.g., 3, of layers of the convolutional layers 410.

In an embodiment, the image 300 may be set as input data for the convolutional layers 410. For example, the image 300 may be one frame of an image according to image information obtained using the camera 241. The image 300 may be composed of a three-dimensional vector of 222×224×3. Based on the output data for the convolutional layers 410, a three-dimensional vector of 7×7×512 may be identified. The three-dimensional vector of 7×7×512 may be set as input data of the FC layers 420. Through the FC layers 420, an object value 452 representing the type (or category) of the object 270 may be output. However, the disclosure is not limited thereto. The object value 452 may represent the position of the object 270 on the image 300.

In an embodiment, the processor 221 may classify the type of the object 270 based on the object value 452. In an embodiment, the processor 221 may classify the type representing the largest probability value among the probabilities of the object value 452 among the types classifiable through the neural network model 400 as the type of the object 270.

According to an embodiment, the processor 221 may set only a specific portion (or the region of interest (ROI)) of the image 300 as input data for the neural network model 400. In an embodiment, the processor 221 may obtain an area (or bounding box) where the object 270 is positioned through an image segmentation model. In an embodiment, the processor 221 may crop the area (or bounding box) where the object 270 is positioned from the image 300. In an embodiment, the processor 221 may set the area (or bounding box) (or ROI) where the cropped object 270 is positioned as input data to the convolutional layers 410.

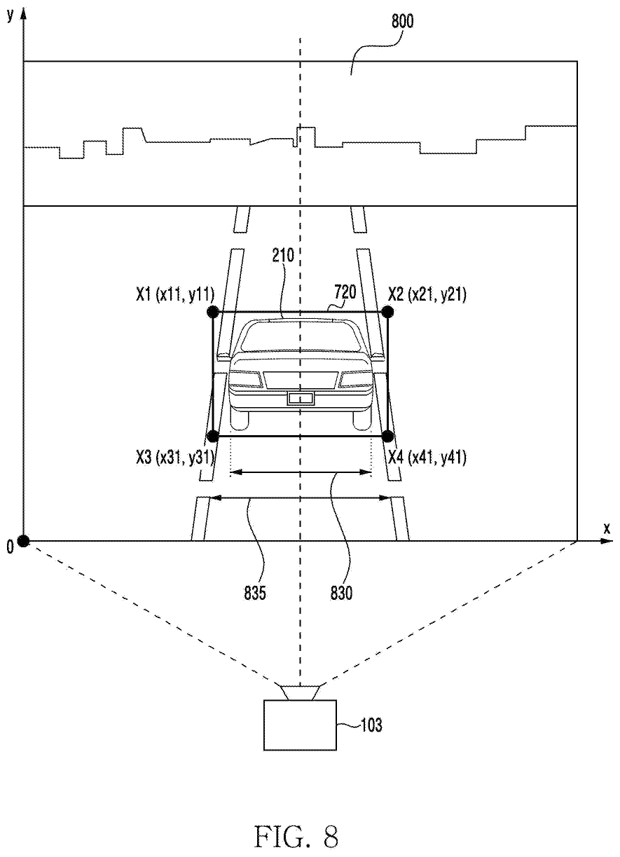

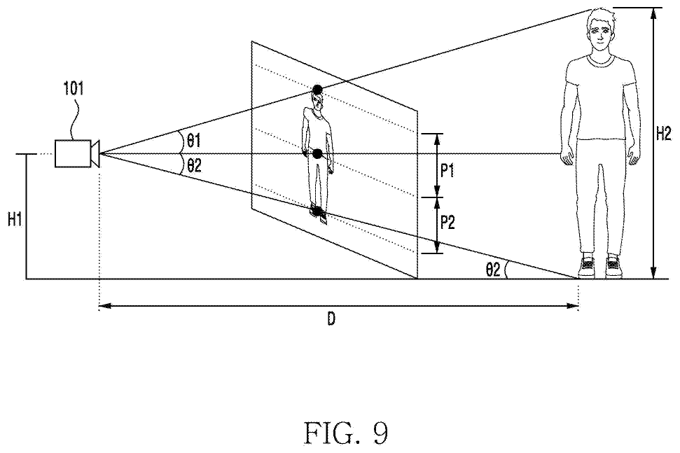

In an embodiment, the processor 221 may transmit data to the electronic devices 103 and 105 through the communication circuitry 211. In an embodiment, the data transmitted to the electronic devices 103 and 105 may include information related to the ambient environment. The information related to the ambient environment may include information related to the external object 270. For example, the external object 270 may be an object positioned around the driving route of the vehicles 210, 230, and 250, and may be an object that should be considered for safe driving. For example, the external object 270 may include, but is not limited to, other vehicles, lines, lanes, traffic lights, crosswalks, pedestrians, animals, and/or speed bumps. In an embodiment, the information related to the external object 270 may indicate the type and/or position of the external object 270 identified through the neural network model 400. In an embodiment, the information related to the external object 270 may include information about the width and/or size of the external object 270. In an embodiment, an operation for obtaining the information about the width and/or size of the external object 270 may be described with reference to FIGS. 8 and 9.

In an embodiment, the processor 221 may transmit an intermediate operation result (or feature map) of the convolutional layers 410, as data, to the electronic devices 103 and 105 through the communication circuitry 211. For example, the intermediate operation result (or feature map) may be an operation result of one layer among the convolutional layers 410. For example, the intermediate operation result (or feature map) may be a value represented as a three-dimensional vector of 128×128×128. For example, the intermediate operation result (or feature map) may be a value represented as a three-dimensional vector of 56×56×256. For example, the intermediate operation result (or feature map) may be a value represented as a three-dimensional vector of 28×28×512. For example, the intermediate operation result (or feature map) may be a value represented as a three-dimensional vector of 14×14×512. For example, the intermediate operation result (or feature map) may be a value represented as a three-dimensional vector of 7×7×512. However, the disclosure is not limited thereto.

In an embodiment, the electronic devices 103 and 105 may obtain object values indicating the type (or category) of the object 270 by inputting the intermediate operation result into the neural network model 400 stored in their memories 233 and 235. In an embodiment, the object values may be the same as or different from the object value 452. In an embodiment, the electronic devices 103 and 105 may classify the type of the object 270 based on object values. In an embodiment, the electronic devices 103 and 105 may classify the type representing the greatest probability value among the respective probabilities of the object values among types classifiable through the neural network model 400 as the type of the object 270. In an embodiment, the classification result of the object 270 of each of the electronic devices 103 and 105 may be the same as or different from the classification result of the object 270 of the electronic device 101.

In an embodiment, the electronic devices 103 and 105 may transmit information about the object value 452 and/or the type (or category) (or classification result) of the object 270 identified based on the object value 452 to the electronic device 101 through the communication circuitry 213 and 215.

In an embodiment, the processor 221 of the electronic device 101 may determine whether to change the classification result of the object 270 based on the object value 452, based on the object value 452 obtained from the electronic devices 103 and 105 and/or information about the type (or category) of the identified object 270 based on the object value 452.

In an embodiment, the processor 221 may determine whether to change the classification result of the object 270 based on the type of the object 270 classified by the largest number of electronic devices among the classification results of the electronic devices 101, 103, and 105. The type of the object 270 classified by the largest number of electronic devices may be referred to as a majority class result (or correct answer). Hereinafter, the classification results other than the majority class result (or correct answer) may be referred to as minority class results (or incorrect answers).

In an embodiment, the processor 221 may not change the classification result of the object 270 based on whether the classification result of the object 270 based on the object value 452 is a majority class result (or a correct answer). In an embodiment, the processor 221 may change the classification result of the object 270 based on whether the classification result of the object 270 based on the object value 452 is a minority class result or an incorrect answer. In an embodiment, that the processor 221 maintains the type (or classification result) of the object 270 may indicate that the classification result of the processor 221 is accurate. In an embodiment, that the processor 221 changes the type (or classification result) of the object 270 may indicate that the classification result of the processor 221 is inaccurate.

In an embodiment, the processor 221 may identify the correct answer rate (or accuracy) of the classification result of the object 270. In an embodiment, the correct answer rate (or accuracy) may be based on correct answers and/or incorrect answers of classification results of the objects 270 performed by the processor 221 during driving of the vehicle 210. For example, the correct answer rate (or accuracy) may represent the ratio of correct answers to classification results of the objects classified by the processor 221.

In an embodiment, the processor 221 may determine whether to change the leading vehicle based on the correct answer rate (or accuracy) of the electronic device 101. In an embodiment, when the correct answer rate (or accuracy) of the electronic device 101 is less than or equal to a reference correct answer rate (or accuracy) (e.g., 95%), the processor 221 may determine to change the leading vehicle. In an embodiment, when the correct answer rate (or accuracy) of the electronic device 101 is less than or equal to the correct answer rate (or accuracy) of the electronic devices 103 and 105 included in the following vehicles, the processor 221 may determine to change the leading vehicle.

In an embodiment, the processor 221 may select a new leading vehicle based on the correct answer rate (or accuracy) of the electronic devices 103 and 105 included in the following vehicles. For example, the processor 221 may select a vehicle equipped with an electronic device having the highest correct answer rate (or accuracy) among the electronic devices 103 and 105 as a new leading vehicle.

In an embodiment, the processor 221 may notify (or transmit) the change of the leading vehicle to the electronic devices 103 and 105 through the communication circuitry 211 based on the selection of a new leading vehicle.

Referring to FIG. 5, based on the change of the leading vehicle from the vehicle 210 to the vehicle 230, the vehicle 210 may leave the platoon for a moment. In an embodiment, the vehicle 210 may move to be positioned after the leading vehicle. In one embodiment, the vehicle 210 may move to be positioned at the very end of the platoon. However, the disclosure is not limited thereto.

As described above, the electronic device 101 may share data (e.g., the intermediate operation results of the convolutional layers 410) smaller than the entire image 300, rather than the entire image 300, with the following vehicles. Accordingly, resources (e.g., communication resources) required for data exchange between the electronic devices 101, 103, and 105 may be reduced.

Further, the electronic device 101 may obtain classification results for data (e.g., the intermediate operation results of the convolutional layers 410) from the electronic devices 103 and 105, so that the platoon may, in group, operate on the external object. Accordingly, the electronic device 101 may be capable of more accurate recognition of the external object.

Further, by changing the vehicle equipped with the electronic device with the highest correct answer rate among the electronic devices 101, 103, and 105 to the leading vehicle, the recognition reliability of the leading vehicle may always be maintained high. Further, when the correct answer rate of the leading vehicle decreases, the leading vehicle may be changed, allowing the recognition reliability of the leading vehicle to remain high.

FIG. 6A schematically illustrates a circumstance in which a following vehicle identifies a hazard while platooning according to an embodiment. FIG. 6B illustrates a front image according to an embodiment.

Referring to FIG. 6A, two or more vehicles 210, 230, and 250 forming a platoon may drive while maintaining a designated formation. The vehicles 210, 230, and 250, respectively, may include electronic devices (e.g., the electronic devices 101, 103, and 105 of FIG. 1) for platooning. The electronic devices 101, 103, and 105 may share control information about the vehicles 210, 230, and 250 and information collected through the electronic devices 101, 103, and 105 respectively disposed in the vehicles 210, 230, and 250 in real-time using V2X communication technology.

In an embodiment, the electronic device (e.g., the electronic device 103 or 105) included in the following vehicle may transmit information related to the ambient environment obtained through the camera 243 or 245 to other electronic devices 101, 103, and 105. For example, the electronic device 103 may transmit a signal related to the ambient environment to each of the electronic devices 101 and 105 respectively disposed in the other vehicles 210 and 250. The electronic devices 101 and 105 may control driving of the vehicles 210 and 250 based on the information related to the ambient environment received from the electronic device 103. For example, the electronic device 105 may transmit a signal related to the ambient environment to each of the electronic devices 101 and 103 respectively disposed in the other vehicles 210 and 230. The electronic devices 101 and 103 may control driving of the vehicles 210 and 230 based on the information related to the ambient environment received from the electronic device 105.

In an embodiment, the information related to the ambient environment may include information related to the external object 270. For example, the external object 270 may be an object positioned around the driving route of the vehicles 210, 230, and 250, and may be an object that should be considered for safe driving. For example, the external object 270 may include, but is not limited to, other vehicles, lines, lanes, traffic lights, crosswalks, pedestrians, animals, and/or speed bumps. In an embodiment, the external object 270 may be an object not identified by the leading vehicle. However, the disclosure is not limited thereto. The external object 270 may be an object identified by the leading vehicle. For example, the external object 270 may be an object with increased risk after being identified by the leading vehicle.

In an embodiment, referring to FIG. 6B, the processor 225 may obtain an image 600 using the camera 245. According to an embodiment, the processor 225 of the electronic device 105 may obtain an image 600 for the outside of the vehicle 250 through the camera 245. The electronic device 105 may obtain an image 600 including an external object 690 in the FoV of the camera 245 using the image 600 obtained through the camera.

According to an embodiment, the processor 225 may identify the object 690 and the type (or category) of the object 690 included in the image 600 using a designated neural network model (e.g., the neural network model 400 of FIG. 4). In an embodiment, the processor 225 may identify a designated type of object (e.g., a vehicle, a traffic sign, or a road mark) through an image segmentation model and/or an object detection model in the image 600.

In an embodiment, the processor 225 may classify the type of the object 690 based on the object value in the image 600 identified using the neural network model 400. In an embodiment, the processor 225 may classify the type representing the greatest probability value among the probabilities of the object value among the types classifiable through the neural network model 400 as the type of the object 690. However, the disclosure is not limited thereto. In an embodiment, the processor 225 may set only a specific portion (or the region of interest (ROI)) of the image 600 as input data for the neural network model 400.

In an embodiment, the processor 225 may transmit data to the electronic devices 101 and 103 through the communication circuitry 215. In an embodiment, the data transmitted to the electronic devices 101 and 103 may include information related to the ambient environment. The information related to the ambient environment may include information (e.g., type, position, and/or size) related to the external object 690.

In an embodiment, the processor 225 may transmit data including information related to the ambient environment to the electronic devices 101 and 103 according to the priorities of the electronic devices 101 and 103. In an embodiment, the priority between the electronic devices 101 and 103 may be determined based on the risk by the external object 690. For example, the electronic device having the highest risk by the external object 690 among the electronic devices 101 and 103 may have the highest priority. For example, the electronic device having the lowest risk by the external object 690 among the electronic devices 101 and 103 may have the lowest priority. For example, the risk of the external object 690 may be the possibility of collision with the electronic device according to the position, moving direction, and/or moving speed of the external object 690. For example, the higher possibility of collision may be evaluated as the higher risk.

In an embodiment, the processor 225 may sequentially transmit data including information related to the ambient environment to the electronic devices 101 and 103 according to the priorities. For example, the processor 225 may transmit data including information related to the ambient environment to the electronic device 103 included in the vehicle 230 with a high possibility of collision by the object 690. Thereafter, the processor 225 may transmit data including information related to the ambient environment to the electronic device 101 included in the vehicle 210 with a relatively low possibility of collision by the object 690.

As described above, the electronic device 105 may preferentially share information related to the ambient environment obtained by the electronic device 105 to an electronic device (e.g., the electronic device 103) requiring it. Accordingly, by preferentially transmitting necessary information to an electronic device that requires immediate response, the possibility of collision may be reduced through avoidance operation of the electronic device or the like.

FIG. 7 illustrates an example of an area to be transferred to a following vehicle in a front image according to an embodiment.

In an embodiment, the electronic devices 101, 103, and 105 may obtain images through the cameras 241, 243, and 245.

In an embodiment, the image obtained by the electronic device 101 equipped to the leading vehicle may be shared (or transferred) (or transferred) to the electronic devices 103 and 105 of the following vehicles. In an embodiment, the feature map (or the output result of the neural network model 400) of the image obtained by the electronic device 101 equipped to the leading vehicle may be shared (or transferred) (or transferred) to the electronic devices 103 and 105 of the following vehicles. In an embodiment, images obtained by the electronic devices 103 and 105

equipped to the following vehicles may then be shared (or transferred) (or transferred) to the electronic devices of the next following vehicles. In an embodiment, the image feature maps (or intermediate operation results of the neural network model 400) (or output results of the neural network model 400) obtained by the electronic devices 103 and 105 equipped to the following vehicles may be shared (or transferred) (or transferred) to the electronic devices of the next following vehicles. For example, the image obtained by the electronic device 103 may be shared with the electronic device 105 of the next following vehicle. For example, the feature map of the image obtained by the electronic device 103 (or the output result of the neural network model 400) may be shared (or transferred) (or transferred) to the electronic device 105 of the next following vehicle.

In an embodiment, the electronic devices 103 and 105 equipped to the following vehicles may share (or transfer) (or transmit) some areas of the obtained images to the electronic devices of the next following vehicles. In an embodiment, some areas may be areas in which preceding vehicles are not included in the image obtained by the electronic devices 103 and 105.

For example, referring to FIG. 7, the electronic device 103 may identify the image 700 through the camera 243. The electronic device 103 may identify an external object corresponding to the preceding vehicle 210 in the image 700. The electronic device 103 may identify a class (or category) of the external object corresponding to the preceding vehicle 210. The electronic device 103 may identify the area 720 corresponding to the external object based on identifying the external object corresponding to the preceding vehicle 210. For example, the area 720 may include first vertices X1, X2, X3, and X4. For example, the electronic device 103 may identify coordinates of each of the first vertices X1, X2, X3, and X4 of the area 720. For example, the coordinates of the first point X1 may be (x11, y11). For example, the coordinates of the second point X2 may be (x21, y21). For example, the coordinates of the third point X3 may be (x31, y31). For example, the coordinates of the fourth point X4 may be (x41, y41).

In an embodiment, the electronic device 103 may identify areas 730 and 735 other than the area 720 corresponding to the external object in the image 700. In an embodiment, the areas 730 and 735 may include an area 730 on the left side of the left vertical line connecting the first point X1 and the third point X3 of the area 720 and an area 735 on the left side of the right vertical line connecting the second point X2 and the fourth point X4 of the area 720. However, the disclosure is not limited thereto. In an embodiment, the areas may include on the upper side of the upper horizontal line connecting the first point X1 and the second point X2 of the area 720 and an area on the lower side of the lower horizon connecting the third point X3 and the fourth point X4 of the area 720.

In an embodiment, the electronic device 103 may then share (or transfer) (or transmit) the areas 730 and 735 in the image 700 to the electronic devices of the next following vehicle. In an embodiment, the electronic device 103 may share (or transfer) (or transmit) one data connecting the areas 730 and 735 in the image 700 to the electronic devices of the next following vehicle. In an embodiment, the electronic device 103 may share (or transfer) (or transmit) each of the areas 730 and 735 in the image 700 to the electronic devices of the next following vehicle.

In an embodiment, the electronic devices of the following vehicle may recognize the driving environment in a complex manner through the areas 730 and 735 in the image 700 obtained from the electronic device of the preceding vehicle and the image obtained through its own camera. For example, the electronic devices of the following vehicle may identify the driving environment through the external object identified through the areas 730 and 735 in the image 700 and the image obtained through its own camera.

According to an embodiment, when the size of data including information related to the ambient environment is large, communication resources may increase between the electronic devices 101, 103, and 105. Accordingly, a method for efficiently reducing the size of data including information related to the ambient environment may be required. Hereinafter, operations for reducing data including information related to the ambient environment may be described with reference to FIG. 7.

According to an embodiment, images obtained by the electronic devices 103 and 105 equipped to the following vehicles may be shared (or transferred) (or transferred) to electronic devices of the preceding vehicle other than the leading vehicle. In an embodiment, the image feature maps (or intermediate operation results of the neural network model 400) (or output results of the neural network model 400) obtained by the electronic devices 103 and 105 equipped to the following vehicles may be shared (or transferred) (or transferred) to the electronic devices of the preceding vehicle other than the leading vehicle. For example, the image obtained by the electronic device 105 may be shared with the electronic device 103 of the preceding vehicle other than the leading vehicle. For example, the feature map of the image obtained by the electronic device 105 (or the output result of the neural network model 400) may be shared (or transferred) (or transferred) to the electronic device 103 of the preceding vehicle other than the leading vehicle.

In an embodiment, the electronic devices 103 and 105 equipped to the following vehicles may share (or transfer) (or transmit) some areas of the obtained images to the electronic devices of the preceding vehicle other than the leading vehicle. In an embodiment, some areas may be areas in which preceding vehicles are not included in the image obtained by the electronic devices 103 and 105.

In an embodiment, the electronic device 103 may then share (or transfer) (or transmit) the areas 730 and 735 in the image 700 to the electronic devices of the next following vehicle. In an embodiment, the electronic device 103 may share (or transfer) (or transmit) one data connecting the areas 730 and 735 in the image 700 to the electronic devices of the next following vehicle. In an embodiment, the electronic device 103 may share (or transfer) (or transmit) each of the areas 730 and 735 in the image 700 to the electronic devices of the next following vehicle.

In an embodiment, the electronic devices of the following vehicle may recognize the driving environment in a complex manner through areas 730 and 735 in the image 700 obtained from the electronic device of the preceding vehicle, areas in the image obtained through the camera of the electronic device of the succeeding vehicle, and an image obtained through their own camera. For example, the electronic devices of the following vehicle may identify the driving environment through the external objects identified through the areas 730 and 735 in the image 700, the external objects identified through the areas in the image obtained through the camera of the electronic device of the succeeding vehicle, and the external objects identified through the image obtained through their own camera.

FIG. 8 illustrates an example of a method for calculating a width of an object in a front image according to an embodiment.

In an embodiment, the processor 221 of the electronic device 101 may obtain width information (e.g., 3.5 meters) about a lane on a road where the vehicle 210 is driving through the communication circuitry 211. In an embodiment, the width information about the lane may be obtained by the communication circuitry 211 through a server, rather than through an image of the camera 241.

In an embodiment, the processor 221 may identify the lane of the road where the vehicle 210 is driving and the width 835 (or the pixel count in the width direction) of the lane through the camera 241. In an embodiment, the processor 221 may identify the width 830 (or the pixel count in the width direction) of the object (e.g., the vehicle 210) through the camera 241. For example, the width 835 (or the pixel count in the width direction) of the lane and the width 830 (or the pixel count in the width direction) of the object (e.g., the vehicle 210) may be identified at the same height (or the same position on the y-axis) in the image 800.

In an embodiment, the processor 221 may identify the length of the object (e.g., the vehicle 210) in the width direction based on the ratio (e.g., B) between the width 835 of the lane (or the pixel count in the width direction) and the width 830 (or the pixel count in the width direction) of the object (e.g., the vehicle 210) and the width information (e.g., 3.5 meters) about the lane. For example, the processor 221 may identify (or calculate) the actual width of the object (e.g., the vehicle 210) by multiplying the ratio (e.g., B) by the actual width (e.g., 3.5 meters) of the lane.

FIG. 9 illustrates an example of a method for calculating a size of an object according to an embodiment.

In an embodiment, the processor 221 of the electronic device 101 may identify the height H2 of the object in contact with the ground. For example, the processor 221 may identify the height H2 of the object based on the height (or the height from the ground) H1 of the camera 241. For example, the processor 221 may identify the height H2 of the object based on the focal length of the camera 241 (or the distance at which the image forms) (or the distance between the camera 241 and the image). For example, the processor 221 may identify the height of the object based on the height P2 from the lower end (or ground) of the object in the image of the camera 241 to the height H1 of the camera 241 (or the center axis of the camera 241). For example, the processor 221 may identify the height of the object based on the heights P1 and P2 of the object in the image of the camera 241.

In an embodiment, the processor 221 may identify the actual distance of the object through a triangular ratio based on the focal length of the camera 241 (or distance at which the image forms) (or the distance between the camera 241 and the image), the height H1, the height P2, and the heights P1 and P2 of the object.

In an embodiment, the processor 221 may identify θ2 based on the focal length of the camera 241 (or the distance at which the image forms) (or the distance between the camera 241 and the image) and the height P2 from the lower end (or ground) of the object to the center axis of the camera 241. For example, the processor 221 may identify θ2 based on tan(θ2) being P2/focal length.

In an embodiment, the processor 221 may identify θ1 based on the focal length of the camera 241 (or the distance at which the image forms) (or the distance between the camera 241 and the image) and the height P1 from the center axis of the camera 241 to the upper end of the object. For example, the processor 221 may identify θ1 based on tan(θ1) being P1/focal length.

In an embodiment, the processor 221 may calculate (or identify) the actual distance D between the camera 241 and the object based on the height H1 and 02 of the camera 241. For example, the processor 221 may identify D based on tan(θ2) being H1/D.

In an embodiment, the processor 221 may identify the height H2 of the object in contact with the ground based on the actual distance D between the camera 241 and the object, θ1, and θ2. For example, the processor 221 may identify H2 based on D×tan(θ1)+D×tan(θ2) being H2.

As described above, the electronic device 101 may identify the distance D between the camera 241 and the actual object through a mono camera.

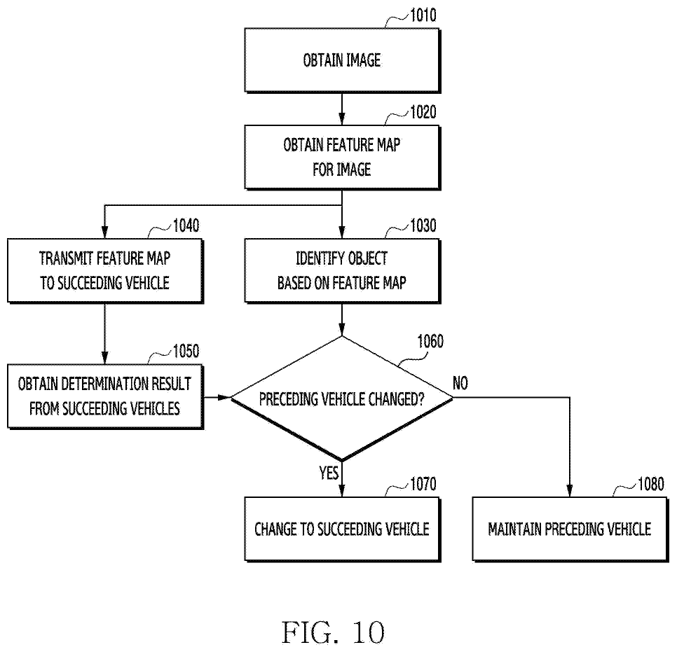

FIG. 10 is a flowchart illustrating an operation method of an electronic device according to an embodiment.

FIG. 10 may be described with reference to FIGS. 1 to 9. Operations of FIG. 10 may be performed by the electronic device 101. The operations of FIG. 10 may be performed by executing instructions stored in the memory 231. The operations of FIG. 10 may be performed by the processor 221 executing instructions stored in the memory 231.

Referring to FIG. 10, in operation 1010, the electronic device 101 may obtain an image 300. According to an embodiment, the electronic device 101 may obtain an image 300 for the outside of the vehicle 210 through the camera 241. The electronic device 101 may obtain an image 300 including an external object 270 in a field-of-view (FoV) of the camera 241 using the image 300 obtained through the camera.

In operation 1020, the electronic device 101 may obtain a feature map for the image 300. The electronic device 101 may obtain a feature map for the image 300 using a designated neural network model 400. For example, the designated neural network model 400 may be composed of a combination of a convolutional layer 410 and an FC layer 420. In an embodiment, the feature map may be an operation result of one of the layers of the convolutional layers 410.

In operation 1030, the electronic device 101 may identify the object 270 based on the feature map. The electronic device 101 may obtain an object value 452 by inputting the feature map of the image 300 to the FC layer 420 of the neural network model 400. In an embodiment, the electronic device 101 may classify the type of the object 270 based on the object value 452. In an embodiment, the electronic device 101 may classify the type representing the largest probability value among the probabilities of the object value 452 among the types classifiable through the neural network model 400 as the type of the object 270.

In operation 1040, the electronic device 101 may transmit the feature map to the succeeding vehicles (e.g., the vehicles 230 and 250). In an embodiment, the electronic device 101 may transmit an intermediate operation result (or feature map) of the convolutional layers 410 to the electronic devices 103 and 105 through the communication circuitry 211. For example, the intermediate operation result (or feature map) may be an operation result of one layer among the convolutional layers 410. For example, the intermediate operation result (or feature map) may be a value represented as a three-dimensional vector of 128×128×128. For example, the intermediate operation result (or feature map) may be a value represented as a three-dimensional vector of 56×56×256. For example, the intermediate operation result (or feature map) may be a value represented as a three-dimensional vector of 28×28×512. For example, the intermediate operation result (or feature map) may be a value represented as a three-dimensional vector of 14×14×512. For example, the intermediate operation result (or feature map) may be a value represented as a three-dimensional vector of 7×7×512. However, the disclosure is not limited thereto.

In operation 1050, the electronic device 101 may obtain a determination result from the succeeding vehicles (e.g., the vehicles 230 and 250).

In an embodiment, the electronic devices 103 and 105 may obtain object values indicating the type (or category) of the object 270 by inputting the intermediate operation result into the neural network model 400 stored in their memories 233 and 235. In an embodiment, the object values may be the same as or different from the object value 452. In an embodiment, the electronic devices 103 and 105 may classify the type of the object 270 based on object values. In an embodiment, the electronic devices 103 and 105 may classify the type representing the greatest probability value among the respective probabilities of the object values among types classifiable through the neural network model 400 as the type of the object 270. In an embodiment, the classification result of the object 270 of each of the electronic devices 103 and 105 may be the same as or different from the classification result of the object 270 of the electronic device 101.

In an embodiment, the electronic devices 103 and 105 may transmit information about the object value 452 and/or the type (or category) (or classification result) of the object 270 identified based on the object value 452 to the electronic device 101 through the communication circuitry 213 and 215.

In operation 1060, the electronic device 101 may determine whether the preceding vehicle needs to be changed. In an embodiment, the electronic device 101 may determine whether the preceding vehicle needs to be changed based on the correct answer rate (or accuracy) of the classification result of the object 270. In an embodiment, the correct answer rate (or accuracy) may be based on correct answers and/or incorrect answers of classification results of the objects 270 performed by the electronic device 101 during driving of the vehicle 210. For example, the correct answer rate (or accuracy) may represent the ratio of correct answers to classification results of the objects classified by the electronic device 101.

In an embodiment, when the correct answer rate (or accuracy) of the electronic device 101 is less than or equal to a reference correct answer rate (or accuracy) (e.g., 95%), the electronic device 101 may determine to change the leading vehicle. In an embodiment, when the correct answer rate (or accuracy) of the electronic device 101 is less than or equal to the correct answer rate (or accuracy) of the electronic devices 103 and 105 included in the following vehicles, the electronic device 101 may determine to change the leading vehicle.

In an embodiment, in operation 1060, based on determining that the preceding vehicle needs to be changed, the electronic device 101 may perform operation 1070. In an embodiment, in operation 1060, based on determining that the preceding vehicle need not be changed, the electronic device 101 may perform operation 1080.

In operation 1070, the electronic device 101 may change the vehicle 210 to a following vehicle. In an embodiment, the electronic device 101 may notify (or transmit) the change of the leading vehicle to the electronic devices 103 and 105 through the communication circuitry 211 based on the change of the leading vehicle.

In an embodiment, based on the change of the leading vehicle from the vehicle 210 to another vehicle, the vehicle 210 may leave the platoon for a moment. In an embodiment, the vehicle 210 may move to be positioned after the leading vehicle. In one embodiment, the vehicle 210 may move to be positioned at the very end of the platoon. However, the disclosure is not limited thereto.

In an embodiment, the electronic device 101 may select a new leading vehicle based on the correct answer rate (or accuracy) of the electronic devices 103 and 105 included in the following vehicles. For example, the electronic device 101 may select a vehicle equipped with an electronic device having the highest correct answer rate (or accuracy) among the electronic devices 103 and 105 as a new leading vehicle. In an embodiment, the processor 221 may notify (or transmit) information about the new leading vehicle to the electronic devices 103 and 105 through the communication circuitry 211 based on the selection of the new leading vehicle.

In operation 1080, the electronic device 101 may maintain the vehicle 210 as the preceding vehicle.

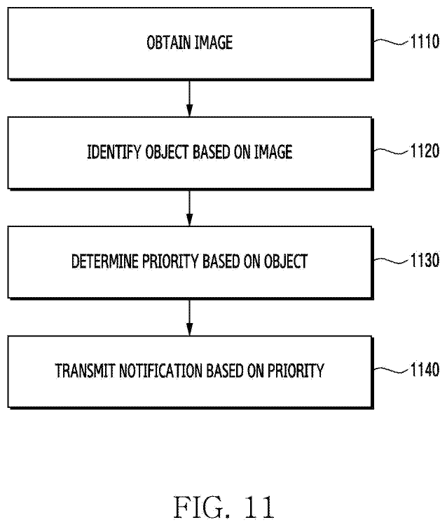

FIG. 11 is a flowchart illustrating an operation method of an electronic device according to an embodiment.

FIG. 11 may be described with reference to FIGS. 1 to 9. Operations of FIG. 11 may be performed by the electronic devices 103 and 105. The operations of FIG. 11 may be performed by executing instructions stored in the memories 233 and 235. The operations of FIG. 11 may be performed as the processors 223 and 225 execute instructions stored in the memories 233 and 235. Hereinafter, the operations of FIG. 11 may be illustrated as being performed by the electronic device 105.

Referring to FIG. 11, in operation 1110, the electronic device 105 may obtain an image 600. According to an embodiment, the electronic device 105 may obtain an image 600 for the outside of the vehicle 250 through the camera 245. The electronic device 105 may obtain an image 600 including an external object 690 in the FoV of the camera 245 using the image 600 obtained through the camera.

In operation 1120, the electronic device 105 may identify the object 690 based on the image 600. According to an embodiment, the electronic device 105 may identify the object 690 and the type (or category) of the object 690 included in the image 600 using a designated neural network model (e.g., the neural network model 400 of FIG. 4). In an embodiment, the electronic device 105 may identify a designated type of object (e.g., a vehicle, a traffic sign, or a road mark) through an image segmentation model and/or an object detection model in the image 600.

In an embodiment, the electronic device 105 may classify the type of the object 690 based on the object value in the image 600 identified using the neural network model 400. In an embodiment, the electronic device 105 may classify the type representing the greatest probability value among the probabilities of the object value among the types classifiable through the neural network model 400 as the type of the object 690. However, the disclosure is not limited thereto. In an embodiment, the electronic device 105 may set only a specific portion (or the region of interest (ROI)) of the image 600 as input data for the neural network model 400.

In operation 1130, the electronic device 105 may identify the priority based on the object 690. In an embodiment, the electronic device 105 may determine priorities between the electronic devices 101 and 103 based on the risk by the external object 690. For example, the electronic device having the highest risk by the external object 690 among the electronic devices 101 and 103 may have the highest priority. For example, the electronic device having the lowest risk by the external object 690 among the electronic devices 101 and 103 may have the lowest priority. For example, the risk of the external object 690 may be the possibility of collision with the electronic device according to the position, moving direction, and/or moving speed of the external object 690. For example, the higher possibility of collision may be evaluated as the higher risk.

In operation 1140, the electronic device 105 may transmit a notification based on the priority. In an embodiment, the electronic device 105 may transmit data including information related to the ambient environment to the electronic devices 101 and 103 according to the priorities of the electronic devices 101 and 103. In an embodiment, the electronic device 105 may sequentially transmit data including information related to the ambient environment to the electronic devices 101 and 103 according to the priorities. For example, the electronic device 105 may transmit data including information related to the ambient environment to the electronic device 103 included in the vehicle 230 with a high possibility of collision by the object 690. Thereafter, the electronic device 105 may transmit data including information related to the ambient environment to the electronic device 101 included in the vehicle 210 with a relatively low possibility of collision by the object 690.

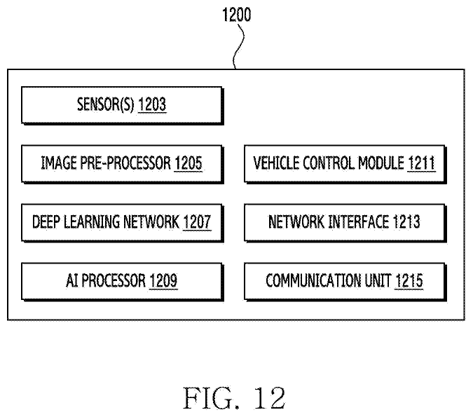

FIG. 12 is a block diagram illustrating an example of an autonomous driving system of a vehicle according to an embodiment.

An autonomous driving system 1200 of a vehicle according to FIG. 12 may be a deep learning network including sensors 1203, an image pre-processor 1205, a deep learning network 1207, an artificial intelligence (AI) processor 1209, a vehicle control module 1211, a network interface 1213, and a communication unit 1215. In various embodiments, the elements may be connected through various interfaces. For example, sensor data sensed and output by the sensors 1203 may be fed to the image pre-processor 1205. The sensor data processed by the image pre-processor 1205 may be fed to the deep learning network 1207 running on the AI processor 1209. The output of the deep learning network 1207 run by the AI processor 1209 may be fed to the vehicle control module 1211. Intermediate results of the deep learning network 1207 running on the AI processor 1209 may be fed to the AI processor 1209. In various embodiments, the network interface 1213 communicates with an electronic device (e.g., the electronic device 101 and/or the electronic devices 103 and 105 of FIG. 2) in the vehicle to transfer autonomous driving route information and/or autonomous driving control commands for autonomous driving of the vehicle to internal block components. In an embodiment, the network interface 1213 may be used to transmit sensor data obtained through the sensor(s) 1203 to an external server. In some embodiments, the autonomous driving control system 1200 may include additional or fewer components as appropriate. For example, in some embodiments, the image pre-processor 1205 may be an optional component. As another example, a post-processing component (not shown) may be included in the autonomous driving control system 1200 to perform post-processing at the output of the deep learning network 1207 before the output is provided to the vehicle control module 1211.

In some embodiments, the sensors 1203 may include one or more sensors. In various embodiments, the sensors 1203 may be attached to different positions of the vehicle. The sensors 1203 may be oriented in one or more different directions. For example, the sensors 1203 may be attached to the front, side, rear, and/or roof of the vehicle to face in different directions such as forward-facing, rear-facing, and side-facing. In some embodiments, the sensors 1203 may be image sensors such as high dynamic range cameras. In some embodiments, the sensors 1203 include non-visual sensors. In some embodiments, the sensors 1203 include radar, LiDAR, and/or ultrasonic sensors in addition to the image sensors. In some embodiments, the sensors 1203 are not mounted to a vehicle having the vehicle control module 1211. For example, the sensors 1203 may be included as part of a deep learning system for capturing sensor data and attached to the environment or road and/or equipped to surrounding vehicles.

In some embodiments, the image pre-processor 1205 may be used to pre-process sensor data of the sensors 1203. For example, the image pre-processor 1205 may be used to pre-process sensor data, split sensor data into one or more components, and/or post-process one or more components. In some embodiments, the image pre-processor 1205 may be a graphics processing unit (GPU), a central processing unit (CPU), an image signal processor, or a specialized image processor. In various embodiments, the image pre-processor 1205 may be a tone-mapper processor for processing high dynamic range data. In some embodiments, the image pre-processor 1205 may be a component of the AI processor 1209.

In some embodiments, the deep learning network 1207 may be a deep learning network for implementing control commands for controlling an autonomous vehicle. For example, the deep learning network 1207 may be an artificial neural network, such as a convolutional neural network (CNN), trained using sensor data, and the output of the deep learning network 1207 is provided to the vehicle control module 1211.

In some embodiments, the artificial intelligence (AI) processor 1209 may be a hardware processor for running the deep learning network 1207. In some embodiments, the AI processor 1209 is a specialized AI processor for performing inference through a convolutional neural network (CNN) on sensor data. In some embodiments, the AI processor 1209 may be optimized for bit depth of sensor data. In some embodiments, the AI processor 1209 may be optimized for deep learning operations, such as operations of a neural network including convolution, dot product, vector and/or matrix operations. In some embodiments, the AI processor 1209 may be implemented through a plurality of graphics processing devices (GPUs) capable of effectively performing parallel processing.

In various embodiments, the AI processor 1209 may be coupled via an input/output interface to memory configured to provide an AI processor having instructions to perform deep learning analysis on sensor data received from the sensor(s) 1203 while the AI processor 1209 is running and to determine a machine learning result used to operate the vehicle at least partially autonomously. In some embodiments, the vehicle control module 1211 may be used to process instructions for vehicle control output from the artificial intelligence (AI) processor 1209 and to translate the output of the AI processor 1209 into instructions for controlling the modules of each vehicle to control various modules of the vehicle. In some embodiments, the vehicle control module 1211 is used to control the vehicle for autonomous driving. In some embodiments, the vehicle control module 1211 may adjust the steering and/or speed of the vehicle. For example, the vehicle control module 1211 may be used to control the driving of the vehicle, such as deceleration, acceleration, steering, lane change, lane keeping, etc. In some embodiments, the vehicle control module 1211 may generate control signals for controlling vehicle lighting, such as brake lights, turn signals, headlights, or the like. In some embodiments, the vehicle control module 1211 may be used to control vehicle audio-related systems, such as the vehicle's sound system, the vehicle's audio warnings, the vehicle's microphone system, the vehicle's horn system, or the like.

In some embodiments, the vehicle control module 1211 may be used to control notification systems that include warning systems for informing passengers and/or the driver of driving events such as approaching the intended destination or potential collisions. In some embodiments, the vehicle control module 1211 may be used to adjust sensors such as the sensors 1203 of the vehicle. For example, the vehicle control module 1211 may modify the orientation direction of the sensors 1203, change the output resolution and/or format type of the sensors 1203, increase or decrease the capture rate, adjust the dynamic range, and adjust the focus of the camera. Further, the vehicle control module 1211 may individually or collectively turn on/off the operations of the sensors.

In some embodiments, the vehicle control module 1211 may be used to change the parameters of the image pre-processor 1205 in such a way as modifying the frequency range of filters, adjusting features and/or edge detection parameters for object detection, or adjusting channels and bit depth. In various embodiments, the vehicle control module 1211 may be used to control autonomous driving of the vehicle and/or a driver assistance function of the vehicle.

In some embodiments, the network interface 1213 may serve as an internal interface between the communication unit 1215 and the block components of the autonomous driving control system 1200. Specifically, the network interface 1213 may be a communication interface for receiving and/or transmitting data including voice data. In various embodiments, the network interface 1213 may be connected to external servers to connect voice calls through the communication unit 1215 or to receive and/or transmit text messages, transmit sensor data, update the software of the vehicle to the autonomous driving system, or update the software of the vehicle's autonomous driving system.

In various embodiments, the communication unit 1215 may include various wireless interfaces of cellular or Wi-Fi methods. For example, the network interface 1213 may be used to receive an update on operation parameters and/or instructions for the sensors 1203, the image pre-processor 1205, the deep learning network 1207, the AI processor 1209, and the vehicle control module 1211 from an external server connected through the communication unit 1215. For example, the machine learning model of the deep learning network 1207 may be updated using the communication unit 1215. According to another example, the communication unit 1215 may be used to update the operation parameters of the image pre-processor 1205, such as image processing parameters, and/or the firmware of the sensors 1203.

In another embodiment, the communication unit 1215 may be used to activate communication for emergency services and emergency contact in an accident or near-accident event. For example, in a collision event, the communication unit 1215 may be used to call emergency services for assistance, and may be used to inform the outside of the collision details and emergency services of the vehicle's position. In various embodiments, the communication unit 1215 may update or obtain the expected arrival time and/or destination position.

According to an embodiment, the autonomous driving system 1200 shown in FIG. 12 may be configured as an electronic device 101 of a vehicle. According to an embodiment, if an autonomous driving release event occurs from the user during autonomous driving of the vehicle, the AI processor 1209 of the autonomous driving system 1200 may control to train autonomous driving software of the vehicle by controlling to input information related to the autonomous driving release event as training set data of the deep learning network.

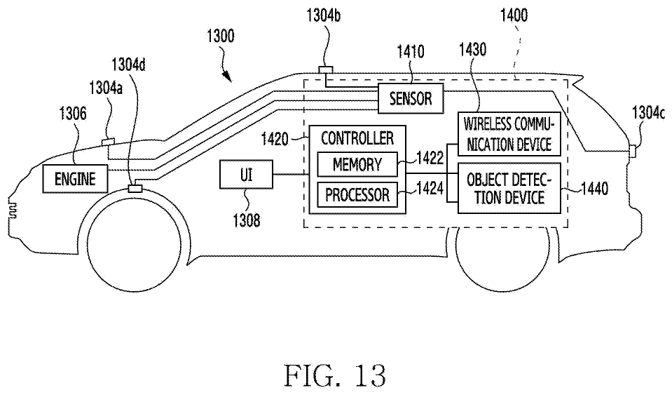

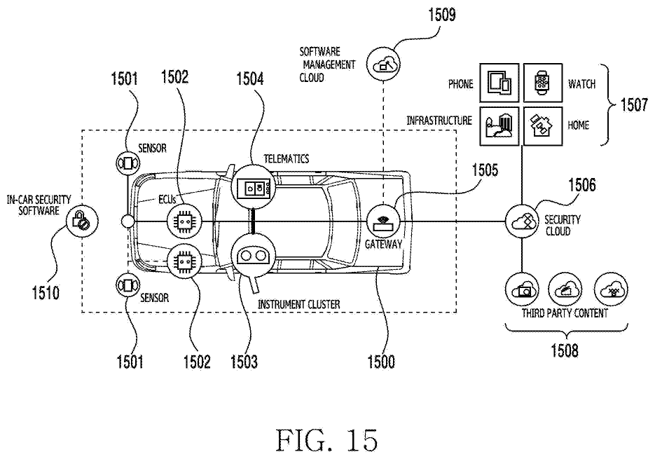

FIGS. 13 and 14 are block diagrams illustrating an example of an autonomous driving moving object according to an embodiment. FIG. 15 illustrates an example of a gateway related to a user device according to various embodiments.

Referring to FIG. 13, an autonomous driving moving object 1300 according to the present embodiment may include a control device 1400, sensing modules 1304a, 1304b, 1304c, and 1304d, an engine 1306, and a user interface 1308. The autonomous driving moving object 1300 may have an autonomous driving mode or a manual mode. For example, according to a user input received through the user interface 1308, the manual mode may be switched to the autonomous driving mode, or the autonomous driving mode may be switched to the manual mode.

When the moving object 1300 is driven in the autonomous driving mode, the autonomous driving moving object 1300 may be driven under the control of the control device 1400.

In the present embodiment, the control device 1400 may include a controller 1420 including memory 1422 and a processor 1424, a sensor 1410, a communication device 1430, and an object detection device 1440.

Here, the object detection device 1440 may perform all or some functions of the distance measurement device.

In other words, in the present embodiment, the object detection device 1440 is a device for detecting an object positioned outside the moving object 1300, and the object detection device 1440 may detect an object positioned outside the moving object 1300 and generate object information according to the detection result.

The object information may include information about the presence or absence of an object, position information about the object, distance information between the moving object and the object, and relative speed information between the moving object and the object.

The object may include various objects positioned outside the moving object 1300 such as lanes, other vehicles, pedestrians, traffic signals, light, roads, structures, speed bumps, terrain, animals, or the like. Here, the traffic signal may be a concept including a traffic light, a traffic sign, and a pattern or text drawn on a road surface. Further, the light may be light generated by a lamp provided in another vehicle, light generated by a street lamp, or sunlight.

Further, the structure may be an object positioned around the road and fixed to the ground. For example, structures may include streetlights, street trees, buildings, power poles, traffic lights, and bridges. The terrain may include mountains, hills, or the like.

The object detection device 1440 may include a camera module. The controller 1420 may extract object information from an external image captured by the camera module and allow the controller 1420 to process the information.

Further, the object detection device 1440 may further include imaging devices for recognizing an external environment. In addition to LIDAR, RADAR, GPS devices, odometry, and other computer vision devices, ultrasonic sensors, and infrared sensors may be used, and these devices may be selected or operated simultaneously as needed to enable more precise detection.

Meanwhile, the distance measurement device according to an embodiment of the disclosure may calculate a distance between the autonomous driving moving object 1300 and the object, and control the operation of the moving object based on the calculated distance in connection with the control device 1400 of the autonomous driving moving object 1300.

For example, when there is a possibility of collision according to the distance between the autonomous driving moving object 1300 and the object, the autonomous driving moving object 1300 may control the brake to reduce the speed or stop. As another example, when the object is a moving object, the autonomous driving moving object 1300 may control the driving speed of the autonomous driving moving object 1300 to maintain a predetermined distance or more from the object.

The distance measurement device according to an embodiment of the disclosure may be configured as a module in the control device 1400 of the autonomous driving moving object 1300. In other words, the memory 1422 and the processor 1424 of the control device 1400 may implement the collision prevention method according to the disclosure in software.

Further, the sensor 1410 may be connected to the sensing modules 1304a, 1304b, 1304c, and 1304d in the internal/external environment of the moving object to obtain various pieces of information. Here, the sensor 1410 may include a posture sensor (e.g., a yaw sensor), a roll sensor, a pitch sensor, a collision sensor, a wheel sensor, a speed sensor, a tilt sensor, a weight detection sensor, a heading sensor, a gyro sensor, a position module, a moving object forward/reverse sensor, a battery sensor, a fuel sensor, a tire sensor, a steering sensor according to the rotation of the steering wheel, a moving object internal temperature sensor, a moving object internal humidity sensor, an ultrasonic sensor, an illumination sensor, an accelerator pedal position sensor, a brake pedal position sensor, or the like.

Accordingly, the sensor 1410 may obtain sensing signals for moving object posture information, moving object collision information, moving object direction information, moving object position information (GPS information), moving object angle information, moving object speed information, moving object acceleration information, moving object slope information, moving object forward/rearward information, battery information, fuel information, tire information, moving object lamp information, moving object internal temperature information, moving object internal humidity information, steering wheel rotation angle, moving object external illumination, pressure applied to the accelerator pedal, pressure applied to the brake pedal, or the like.

Further, the sensor 1410 may further include an accelerator pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), or the like.

As such, the sensor 1410 may generate moving object state information based on the sensing data.

The wireless communication device 1430 is configured to implement wireless communication between the autonomous driving moving objects 1300. For example, it allows the autonomous driving moving object 1300 to communicate with the user's mobile phone or another wireless communication device 1430, another moving object, a central device (traffic control device), a server, etc. The wireless communication device 1430 may transmit and receive wireless signals according to an access wireless protocol. The wireless communication protocol may be Wi-Fi, Bluetooth, long-term evolution (LTE), code division multiple access (CDMA), wideband code division multiple access (WCDMA), and global systems for mobile communications (GSM), but the communication protocols are not limited thereto.

Further, in the present embodiment, the autonomous driving moving object 1300 may implement communication between moving objects through the wireless communication device 1430. In other words, the wireless communication device 1430 may communicate with other moving objects and other moving objects on the road through vehicle-to-vehicle communication (V2V) communication. The autonomous driving moving object 1300 may transmit and receive information such as a driving warning and traffic information through vehicle-to-vehicle communication, and may send or receive a request for information to/from another moving object. For example, the wireless communication device 1430 may perform V2V communication by a short-range communication (dedicated short-range communication (DSRC)) device or a cellular-V2V (C-V2V) device. In addition to vehicle-to-vehicle communication, communication between the vehicle and another object (e.g., an electronic device carried by a pedestrian) (vehicle-to-everything (V2X) communication)) may also be implemented through the wireless communication device 1430.

Further, the wireless communication device 1430 may obtain information generated by infrastructures (traffic lights, CCTVs, RSUs, eNode Bs, etc.) positioned on the road or various mobilities including other autonomous driving/non-autonomous driving vehicles, as information for performing autonomous driving by the autonomous driving moving object 1300 through a non-terrestrial network rather than a terrestrial network.

For example, the wireless communication device 1430 may perform wireless communication with a low-earth orbit (LEO) satellite system, a medium-earth orbit (MEO) satellite system, a geostationary orbit (GEO) satellite system, or a high altitude platform (HAP) system constituting non-terrestrial networks through a non-terrestrial network-dedicated antenna mounted on the autonomous driving moving object 1300.

For example, the wireless communication device 1430 may perform wireless communication with various platforms constituting an NTN according to a radio access standard according to the fifth-generation new radio non-terrestrial network (5G NR NTN) standard, which is currently being discussed in the 3GPP.

In the present embodiment, the controller 1420 may select a platform capable of properly performing NTN communication considering various pieces of information such as the position, current time, and available power of the autonomous driving moving object 1300, and control the wireless communication device 1430 to perform wireless communication with the selected platform.

In the present embodiment, the controller 1420 is a unit that controls the overall operation of each unit in the moving object 1300, and may be configured at the time of manufacture by the manufacturer of the moving object or may be additionally configured to perform an autonomous driving function after manufacturing. Alternatively, a configuration for performing consecutive additional functions may be included through an upgrade of the controller 1420 configured at the time of manufacture. The controller 1420 may be referred to as an electronic control unit (ECU).

The controller 1420 may collect various data from the connected sensor 1410, the object detection device 1440, the communication device 1430, and transfer control signals to the sensor 1410, the engine 1306, the user interface 1308, the communication device 1430, and the object detection device 1440 included as other components in the moving object based on the collected data. Further, although not shown, control signals may also be transferred to the acceleration device, braking system, steering device, or navigation device related to the driving of the moving object.

In the present embodiment, the controller 1420 may control the engine 1306 and, for example, detect the speed limit of the road where the autonomous driving moving object 1300 is driving and control the engine 1306 so that the driving speed does not exceed the speed limit or control the engine 1306 to accelerate the driving speed of the autonomous driving moving object 1300 within a range in which the speed limit is not exceeded.

Further, if the autonomous driving moving object 1300 is approaching or leaving the lane while the autonomous driving moving object 1300 is driving, the controller 1420 determines whether approaching and leaving the lane are based on a normal driving situation or other driving conditions, and controls the engine 1306 to control the driving of the moving object according to the determination result. Specifically, the autonomous driving moving object 1300 may detect the lanes formed on two opposite sides of the lane where the moving object is driving. In this case, the controller 1420 may determine whether the autonomous driving moving object 1300 is approaching or leaving the lane and, if determining that the autonomous driving moving object 1300 is approaching or leaving the lane, determine whether such driving is due to an accurate driving circumstance or another driving circumstance. Here, an example of the normal driving circumstance may be a circumstance where the vehicle needs to change lanes. An example of the other driving circumstance may be a circumstance where the vehicle need not change lanes. If the controller 1420 determines that the autonomous driving moving object 1300 is approaching or leaving the lane in a circumstance where the lane change of the moving object is not required, the controller 1420 may control the driving of the autonomous driving moving object 1300 so that the autonomous driving moving object 1300 does not leave the lane but drives normally.

If there is another moving object or obstruction in front of the moving object, the engine 1306 or the braking system may be controlled to decelerate the driving moving object and, in addition to speed, the trajectory, driving route, and steering angle may be controlled. Alternatively, the controller 1420 may control the driving of the moving object by generating necessary control signals according to recognition information about other external environments such as driving lanes and driving signals of the moving object.

In addition to generating its own control signal, the controller 1420 may control the driving of the moving object by performing communication with a peripheral moving object or a central server and transmitting a command for controlling peripheral devices through the received information.

Further, when the position of the camera module 1450 is changed or the angle of view is changed, it may be impossible to accurately recognize the moving object or lane according to the present embodiment. Thus, to prevent such issue, the controller 1420 may generate a control signal to control to perform calibration on the camera module 1450. Therefore, in the present embodiment, the controller 1420 may generate a calibration control signal to the camera module 1450 to maintain the normal mounting position, direction, and angle of view of the camera module 1450 even when the mounting position of the camera module 1450 is changed by vibration or impact generated by the movement of the autonomous driving moving object 1300. The controller 1420 may generate a control signal to perform calibration on the camera module 1420 when the pre-stored initial mounting position, direction, and angle-of-view information about the camera module 1420 and the initial mounting position, direction, and angle-of-view information about the camera module 1420 measured during the driving of the autonomous driving moving object 1300 are varied by a threshold or more.

In the present embodiment, the controller 1420 may include memory 1422 and a processor 1424. The processor 1424 may execute the software stored in the memory 1422 according to a control signal from the controller 1420. Specifically, the controller 1420 stores data and instructions for performing the lane detection method according to the disclosure in the memory 1422, and the instructions may be executed by the processor 1424 to implement one or more methods disclosed herein.

In this case, the memory 1422 may be stored in a non-volatile recording medium executable by the processor 1424. The memory 1422 may store software and data through a suitable internal/external device. The memory 1422 may be composed of a random access memory (RAM), a read only memory (ROM), a hard disk, and a memory device 1422 connected to a dongle.

The memory 1422 may store, at least, an operating system (OS), user applications, and executable commands. The memory 1422 may also store application data and array data structures.

The processor 1424 may be a controller as a microprocessor or an appropriate electronic processor, a micro controller, or a state machine.

The processor 1424 may be implemented as a combination of computing devices, and the computing device may be composed of a digital signal processor, a microprocessor, or an appropriate combination thereof.

Meanwhile, the autonomous driving moving object 1300 may further include a user interface 1308 for the user's input to the above-described control device 1400. The user interface 1308 may allow the user to enter information through appropriate interaction. For example, it may be implemented as a touch screen, a keypad, an operation button, or the like. The user interface 1308 may transmit an input or command to the controller 1420, and the controller 1420 may perform a control operation of the moving object in response to the input or command.

Further, the user interface 1308 may communicate with the autonomous driving moving object 1300 through the wireless communication device 1430 as a device outside the autonomous driving moving object 1300. For example, the user interface 1308 may enable interworking with a mobile phone, tablet, or other computer devices.

Further, although the autonomous driving moving object 1300 includes the engine 1306 in the present embodiment, other types of propulsion systems. For example, the moving object may be operated by electrical energy, and may be operated by hydrogen energy or a hybrid system in combination thereof. Therefore, the controller 1420 may include a propulsion mechanism according to the propulsion system of the autonomous driving moving object 1300, and may provide a control signal according thereto to the components of each propulsion mechanism.

Hereinafter, a detailed configuration of a control device 1400 according to the present embodiment is described in more detail with reference to FIG. 14.

The control device 1400 includes a processor 1424. The processor 1424 may be a general-purpose single or multi-chip microprocessor, a dedicated microprocessor, a microprocessor, a programmable gate array, or the like. The processor may be referred to as a central processing unit (CPU). Further, in the present embodiment, processor 1424 may be used as a combination of multiple processors.

The control device 1400 also includes memory 1422. The memory 1422 may be any electronic component capable of storing electronic information. The memory 1422 may include a combination of the memories 1422 as well as a single memory.

Data and instructions 1422a for performing the distance measuring method of the distance measurement device according to the disclosure may be stored in the memory 1422. When the processor 1424 executes the instructions 1422a, all or some of the instructions 1422a and the data 1422b required to execute the instructions 1422a may be loaded (1424a and 924b) on the processor 1424.

The control device 1400 may include a transmitter 1430a, a receiver 1430b, or a transceiver 1430c for allowing transmission and reception of signals. One or more antennas 1432a and 1432b may be electrically connected to the transmitter 1430a, the receiver 1430b, or each transceiver 1430c, and may additionally include antennas.

The control device 1400 may include a digital signal processor (DSP) 1470. The DSP 1470 may allow the moving object to quickly process the digital signal.

The control device 1400 may include a communication interface 1480. The communication interface 1480 may include one or more ports and/or communication modules for connecting other devices to the control device 1400. The communication interface 1480 may enable the user and the control device 1400 to interact with each other.

Various components of the control device 1400 may be connected together by one or more buses 1490, and the buses 1490 may include a power bus, a control signal bus, a status signal bus, a data bus, or the like. Under the control of the processor 1424, the components may transfer information therebetween through the bus 1490 and perform a desired function.

Meanwhile, in various embodiments, the control device 1400 may be related to a gateway for communication with a secure cloud. For example, referring to FIG. 15, the control device 1400 may be related to the gateway 1505 for providing information obtained from at least one of the components 1501 to 1504 of the vehicle 1500 to the secure cloud 1506. For example, the gateway 1505 may be included in the control device 1400. As another example, the gateway 1505 may be configured as a separate device within the vehicle 1500 that is distinguished from the control device 1400. The gateway 1505 communicatively connects a software management cloud 1509, a secure cloud 1506, and a network in the vehicle 1500 secured by in-vehicle security software 1510 having different networks.

For example, the component 1501 may be a sensor. For example, the sensor may be used to obtain information about at least one of the state of the vehicle 1500 or the state around the vehicle 1500. For example, the component 1501 may include a sensor 1410.

For example, the component 1502 may be an electronic control unit (ECU). For example, the ECUs may be used for engine control, transmission control, airbag control, tire pressure management.

For example, the component 1503 may be an instrument cluster. For example, the instrument cluster may refer to a panel positioned in front of the driver's seat in the dashboard. For example, the instrument cluster may be configured to show the driver (or passenger) the information necessary for driving. For example, the instrument cluster may be used to display at least one of visual elements to indicate the engine's revolutions per minute or rotations per minute (RPM), visual elements to indicate the speed of the vehicle 1500, visual elements to indicate the amount of remaining fuel, visual elements to indicate the state of the gear, or visual elements to indicate information obtained through the component 1501.

For example, the component 1504 may be a telematics device. For example, the telematics device may refer to a device that combines wireless communication technology and global positioning system (GPS) technology to provide various mobile communication services such as location information and safe driving within the vehicle 1500. For example, the telematics device may be used to connect the driver, a cloud (e.g., the secure cloud 1506), and/or the ambient environment and the vehicle 1500. For example, the telematics device may be configured to support high bandwidth and low latency for 5G NR-standard technology (e.g., 5G NR V2X technology, 5G NR's non-terrestrial network (NTN) technology). For example, the telematics device may be configured to support autonomous driving of the vehicle 1500.

For example, the gateway 1505 may be used to connect the software management cloud 1509 and the secure cloud 1506, which are an in-vehicle (1500) network and an out-of-vehicle network. For example, the software management cloud 1509 may be used to update or manage at least one software required for driving and managing the vehicle 1500. For example, the software management cloud 1509 may be linked to in-vehicle (or in-car) security software 1010 installed in the vehicle. For example, the in-vehicle security software 1510 may be used to provide a security function within vehicle 1500. For example, the in-vehicle security software 1510 may encrypt data transmitted and received through an in-vehicle network using an encryption key obtained from an external authorized server for encryption of the in-vehicle network. In various embodiments, the encryption key used by the in-vehicle security software 1510 may be generated corresponding to vehicle identification information (vehicle license plate, vehicle identification number (VIN)) or information uniquely assigned to each user (user identification information).

In various embodiments, the gateway 1505 may transmit data encrypted by the in-vehicle security software 1510 based on the encryption key to the software management cloud 1509 and/or the secure cloud 1506. The software management cloud 1509 and/or the secure cloud 1506 may identify the data received from which vehicle or from which user by decrypting the data encrypted by the encryption key of the in-vehicle security software 1510 using a decryption key capable of decrypting the encrypted data. For example, since the decryption key is a unique key corresponding to the encryption key, the software management cloud 1509 and/or the secure cloud 1506 may identify the transmission entity (e.g., the vehicle or the user) of the data based on the data decrypted through the decryption key.

For example, the gateway 1505 is configured to support the in-vehicle security software 1510 and may be related to the control device 1400. For example, the gateway 1505 may be related to the control device 1400 to support the connection between the client device 1007 connected to the secure cloud 1506 and the control device 1400. As another example, the gateway 1505 may be related to the control device 1400 to support the connection between the third-party cloud 1508 connected to the secure cloud 1506 and the control device 1400. However, the disclosure is not limited thereto.

In various embodiments, the gateway 1505 may be used to connect the vehicle 1500 with the software management cloud 1509 for managing the operating software of the vehicle 1500. For example, the software management cloud 1509 may monitor whether the operating software of the vehicle 1500 is updated and provide data for updating the operating software of the vehicle 1500 through the gateway 1505 based on monitoring that the operating software of the vehicle 1500 is required to be updated. As another example, the software management cloud 1509 may receive a user request for updating the operating software of the vehicle 1500 from the vehicle 1500 through the gateway 1505, and provide data for updating the operating software of the vehicle 1500 based on the reception. However, the disclosure is not limited thereto.

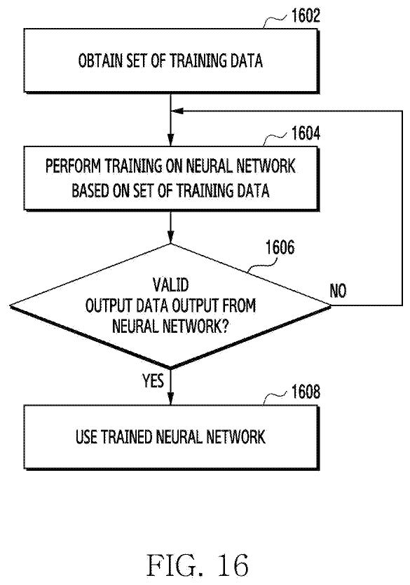

FIG. 16 is a view illustrating operations of an electronic device training a neural network based on a set of training data according to an embodiment.

The operations described with reference to FIG. 16 may be performed by the above-described electronic device (e.g., the electronic device 101 of FIG. 2).

Referring to FIG. 16, in operation 1602, the electronic device may obtain a set of training data according to an embodiment. The electronic device may obtain a set of training data for supervised learning. The training data may include a pair of input data and ground truth data corresponding to the input data. The ground truth data may indicate output data to be obtained from a neural network that has received input data, which forms the pair with the ground truth data. The ground truth data may be obtained by the above-described electronic device.

For example, when training the neural network for image recognition, the training data may include images and information about one or more subjects included in the images. The information may include the category or class of subjects identifiable through the image. The information may include the position, width, height, and/or size of the visual object corresponding to the subject in the image. The set of training data identified through operation 1602 may include pairs of a plurality of training data. In the example of training the neural network for image recognition, the set of training data identified by the electronic device may include a plurality of images and ground truth data corresponding to each of the plurality of images.

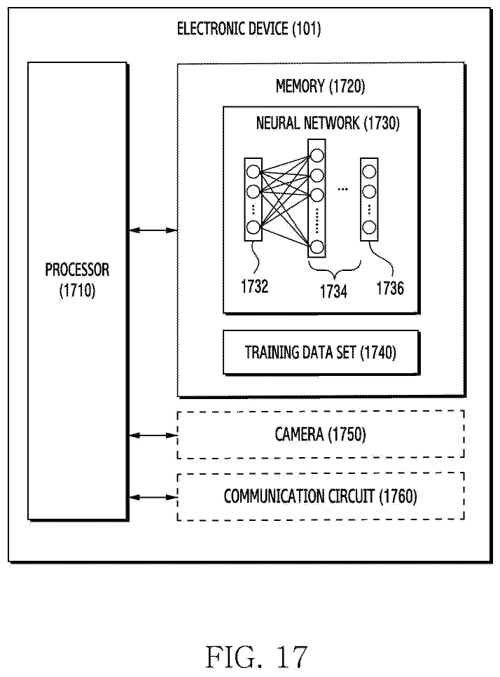

Referring to FIG. 16, in operation 1604, the electronic device according to an embodiment may perform training on the neural network based on the set of training data. In an embodiment in which the neural network is trained based on supervised learning, the electronic device may input input data included in the training data to the input layer of the neural network. An example of the neural network including the input layer is described with reference to FIG. 17. From the output layer of the neural network receiving the input data through the input layer, the electronic device may obtain output data of the neural network corresponding to the input data.

In an embodiment, the training of operation 1604 may be performed based on a difference between the output data and the ground truth data included in the training data and corresponding to the input data. For example, the electronic device may adjust one or more parameters (e.g., weights described below with reference to FIG. 17) related to the neural network to reduce the difference based on a gradient descent algorithm. The operation of the electronic device adjusting the one or more parameters may be referred to as tuning of the neural network. The electronic device may perform tuning of the neural network based on output data using a function defined to evaluate the performance of the neural network, such as a cost function. The difference between the above-described output data and the ground truth data may be included as an example of the cost function.

Referring to FIG. 16, in operation 1606, according to an embodiment, the electronic device may identify whether valid output data is output from the neural network trained in operation 1604. That the output data is valid may mean that the difference (or cost function) between the output data and the ground truth data meets a condition set for use of the neural network. For example, when the average and/or maximum value of the difference between the output data and the ground truth data is less than or equal to a designated threshold, the electronic device may determine that valid output data is output from the neural network.

When valid output data is not output from the neural network (No in 1606), the electronic device may repeatedly perform training of the neural network based on operation 1604. The embodiments are not limited thereto, and the electronic device may repeatedly perform operations 1602 and 1604.

In a state in which valid output data is obtained from the neural network (Yes in 1606), based on operation 1608, the electronic device according to an embodiment may use the trained neural network. For example, the electronic device may input other input data distinct from the input data input to the neural network as training data, to the neural network. The electronic device may use the output data obtained from the neural network receiving the other input data as a result of performing inference on the other input data based on the neural network.

FIG. 17 is a block diagram illustrating an electronic device according to an embodiment.

The electronic device 101 of FIG. 17 may include the above-described electronic device.

For example, the operations described with reference to FIG. 16 may be performed by the electronic device 101 of FIG. 17 and/or the processor 1710 of FIG. 17.

Referring to FIG. 17, the processor 1710 of the electronic device 101 may perform computations related to the neural network 1730 stored in the memory 1720. The processor 1710 may include at least one of a center processing unit (CPU), a graphic processing unit (GPU), and a natural processing unit (NPU). The NPU may be implemented as a chip separated from the CPU, or integrated into a chip such as a CPU in the form of a system on chip (SoC). The NPU integrated into the CPU may be referred to as a neural core and/or an artificial intelligence (AI) accelerator.

Referring to FIG. 17, the processor 1710 may identify the neural network 1730 stored in the memory 1720. The neural network 1730 may include a combination of an input layer 1732, one or more hidden layers 1734 (or intermediate layers), and an output layer 1736. The above-described layers (e.g., the input layer 1732, the one or more hidden layers 1734, and the output layer 1736) may include a plurality of nodes. The number of hidden layers 1734 may vary according to an embodiment, and a neural network 1730 including the plurality of hidden layers 1734 may be referred to as a deep neural network. The operation of training the deep neural network may be referred to as deep learning.

In an embodiment, when the neural network 1730 has a structure of a feed forward neural network, the first node included in a specific layer may be connected to all of the second nodes included in other layers before the specific layer. Parameters stored for the neural network 1730 in the memory 1720 may include weights assigned to connections between the second nodes and the first node. In the neural network 1730 having a structure of a feed forward neural network, the value of the first node may correspond to a weighted sum of values allocated to the second nodes, based on the weights assigned to connections connecting the second nodes and the first node.

In an embodiment, when the neural network 1730 has a structure of a convolutional neural network, the first node included in a specific layer may correspond to a weighted sum of some of the second nodes included in other layers before the specific layer. Some of the second nodes corresponding to the first node may be identified by a filter corresponding to the specific layer. The parameters stored for the neural network 1730 in the memory 1720 may include weights indicating the filter. The filter may include, among the second nodes, one or more nodes to be used to calculate the weighted sum of the first node, and weights respectively corresponding to the one or more nodes.

According to an embodiment, the processor 1710 of the electronic device 101 may perform training on the neural network 1730 using the training data set 1740 stored in the memory 1720. Based on the training data set 1740, the processor 1710 may perform the operations described with reference to FIG. 16 to adjust one or more parameters stored in the memory 1720 for the neural network 1730.

According to an embodiment, the processor 1710 of the electronic device 101 may perform object detection, object recognition, and/or object classification using the neural network 1730 trained based on the training data set 1740. The processor 1710 may input the image (or video) obtained through the camera 1750 into the input layer 1732 of the neural network 1730. Based on the input layer 1732 to which the image is input, the processor 1710 may sequentially obtain the values of nodes of layers included in the neural network 1730 to obtain a set (e.g., output data) of values of nodes of the output layer 1736. The output data may be used as a result of inferring information included in the image using the neural network 1730. The embodiments are not limited thereto, and the processor 1710 may input the image (or video) obtained from the external electronic device connected to the electronic device 101 through the communication circuitry 1760 into the neural network 1730.

In an embodiment, the neural network 1730 trained to process the image may be used to identify the area corresponding to the subject in the image (object detection), and/or to identify the class of the subject represented in the image (object recognition and/or object classification). For example, the electronic device 101 may segment the area corresponding to the subject in the image based on a rectangular shape such as a bounding box using the neural network 1730. For example, the electronic device 101 may identify at least one class matching the subject among a plurality of designated classes using the neural network 1730.

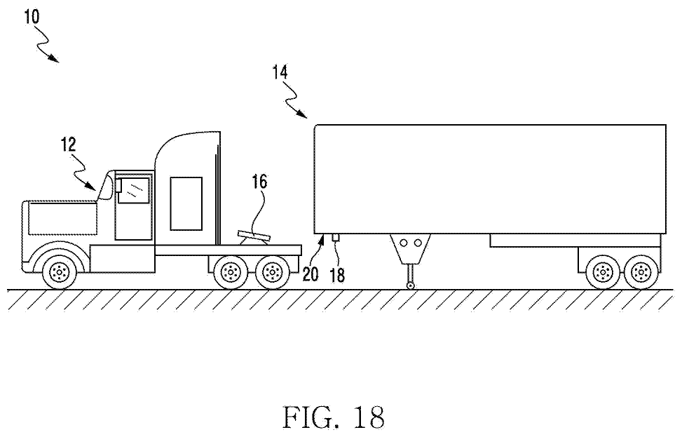

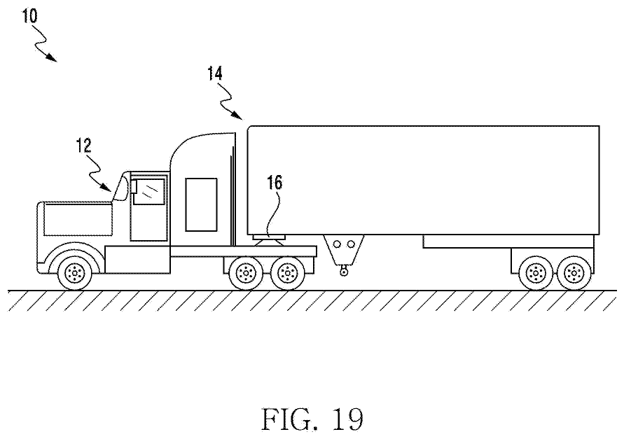

A conventional truck 10 is illustrated in FIGS. 18 and 19.

FIG. 18 illustrates a state in which the tractor 12 and the trailer 14 are not connected.

FIG. 19 illustrates a state in which the tractor 12 and the trailer 14 are connected. In an embodiment of the disclosure, the trailer 14 is selectively connected by a fifth wheel hitch 16 carried by the tractor 12, which engages the kingpin 18 fixed to the trailer 14 in a known manner.

The trailer 20 shown in FIG. 18 of the disclosure is illustrated as a “semi-trailer”, but this is for convenience of description, and it should not be understood that the embodiments of the disclosure are applied only to a “semi-trailer” form.

As described above, an electronic device 101 may comprise a camera 241, communication circuitry 211, memory 231 storing a neural network model 400 and instructions, and a processor 221 operably coupled to the camera 241, the communication circuitry 211, and the memory 231. The instructions may, when executed by the processor 221, cause the electronic device 101 to obtain, through the camera 241, an image 300. The instructions may, when executed by the processor 221, cause the electronic device 101 to identify, using the image 300 and the neural network model 400, a first classification result of an object 270 included in the image 300. The instructions may, when executed by the processor 221, cause the electronic device 101 to transmit, through the communication circuitry 211, to external electronic devices included in vehicles 230 and 250 subsequent to a vehicle 210 equipped with the electronic device 101, a feature map of the neural network model 400 based on the image 300. The instructions may, when executed by the processor 221, cause the electronic device 101 to obtain, through the communication circuitry 211, from the external electronic devices 103 and 105, second classification results of the object 270 which are calculated based on the feature map by the external electronic devices 103 and 105. The instructions may, when executed by the processor 221, cause the electronic device 101 to determine, based on the first classification result and the second classification results, whether to drive the vehicle 210 as a preceding vehicle.

The instructions may, when executed by the processor 221, cause the electronic device 101 to identify, based on the first classification result and the second classification results, whether the first classification result is correct. The instructions may, when executed by the processor 221, cause the electronic device 101 to based on the first classification result being incorrect, determine that the vehicle 210 drives as a succeeding vehicle. The instructions may, when executed by the processor 221, cause the electronic device 101 to, based on the first classification result being correct, determine that the vehicle 210 drives as the preceding vehicle.

The instructions may, when executed by the processor 221, cause the electronic device 101 to identify, based on the first classification result and the second classification results, correct rates of the electronic device 101 and the external electronic devices 103 and 105. The instructions may, when executed by the processor 221, cause the electronic device 101 to determine a vehicle (e.g., the vehicle 230) equipped with an electronic device (e.g., the electronic device 103) having a highest correct rate among the correct rates as the preceding vehicle.

The instructions may, when executed by the processor 221, cause the electronic device 101 to identify a communication environment. The instructions may, when executed by the processor 221, cause the electronic device 101 to, based on a communication speed according to the communication environment being lower than or equal to a reference communication speed, transmit, to the external electronic devices 103 and 105 through the communication circuitry 211, the first classification result except for the feature map. The instructions may, when executed by the processor 221, cause the electronic device 101 to, based on the communication speed according to the communication environment exceeding the reference communication speed, transmit, to the external electronic devices 103 and 105 through the communication circuitry 211, the feature map and the first classification result.

The instructions may, when executed by the processor 221, cause the electronic device 101 to obtain, through the communication circuitry 211, width information about a lane of a road on which the vehicle 210 drives. The instructions may, when executed by the processor 221, cause the electronic device 101 to identify a first pixel count of the width of the lane and a second pixel count in a width direction of the object 270 included in the image 300. The instructions may, when executed by the processor 221, cause the electronic device 101 to identify, based on a ratio between the first pixel count and the second pixel count and the width information about the lane, a length in the width direction of the object 270.

The instructions may, when executed by the processor 221, cause the electronic device 101 to identify a class indicated by the plurality of classification results among the first classification result and the second classification result as the class of the object 270.

As described above, an electronic device 105 may comprise a camera 245, communication circuitry 215, memory 235 storing a neural network model 400 and instructions, and a processor 225 operably coupled to the camera 245, the communication circuitry 215, and the memory 235. The instructions may, when executed by the processor 225, cause the electronic device 105 to obtain, through the camera 245, an image 600. The instructions may, when executed by the processor 225, cause the electronic device 105 to identify, using the image 600 and a neural network model 400, an area where a preceding vehicle 230 is included in the image 600. The instructions may, when executed by the processor 225, cause the electronic device 105 to transmit, through the communication circuitry 215, to external electronic devices included in vehicles subsequent to a vehicle 250 equipped with the electronic device 105, remaining areas 730 and 735 other than the area 720 in the image 600.

The instructions may, when executed by the processor 225, cause the electronic device 105 to obtain a feature map, through the communication circuitry 215 from an external electronic device 101 equipped to a leading vehicle 210. The instructions may, when executed by the processor 225, cause the electronic device 105 to obtain a classification result of an object 270 related to the feature map, using the feature map and the neural network model 400. The instructions may, when executed by the processor 225, cause the electronic device 105 to transmit the classification result to the external electronic device 101 through the communication circuitry 215.

The instructions may, when executed by the processor 225, cause the electronic device 105 to identify, using the image 600 and a neural network model 400, the object 270 in the image 600. The instructions may, when executed by the processor 225, cause the electronic device 105 to identify a possibility of collision between the object 270 and each of vehicles 210 and 230 other than the vehicle 210 equipped with the electronic device 105. The instructions may, when executed by the processor 225, cause the electronic device 105 to transmit, through the communication circuitry 215, information about the identified object 270 to an external electronic device 103 equipped to a first vehicle 230 with the highest possibility of collision among the other vehicles 210 and 230.

The instructions may, when executed by the processor 225, cause the electronic device 105 to transmit the information about the identified object 270 to external electronic devices 101 equipped to the remaining other vehicles 210 after transmitting the information about the identified object 270 to the external electronic device 101 equipped to the first vehicle 230 through the communication circuitry 215.

The above-described method may be performed by an electronic device 101 including a camera 241 and communication circuitry 211. The method may comprise obtaining, through the camera 241, an image 300. The method may comprise identifying, using the image 300 and a neural network model 400, a first classification result of an object 270 included in the image 300. The instructions may, when executed by the processor 221, cause the electronic device 101 to transmit, through the communication circuitry 211, to external electronic devices included in vehicles 210 subsequent to a vehicle 210 equipped with the electronic device 101, a feature map of the neural network model 400 based on the image 300. The method may comprise obtaining, through the communication circuitry 211, from the external electronic devices 101, second classification results of the object 270 which are calculated based on the feature map by the external electronic devices 101. The method may comprise determining, based on the first classification result and the second classification results, whether to drive the vehicle 210 as a preceding vehicle 210.

The method may comprise identifying, based on the first classification result and the second classification results, whether the first classification result is correct. The method may comprise, based on the first classification result being incorrect, determining that the vehicle 210 drives as a succeeding vehicle 210. The method may comprise, based on the first classification result being correct, determining that the vehicle 210 drives as the preceding vehicle 210.

The method may comprise identifying, based on the first classification result and the second classification results, correct rates of the electronic device 101 and the external electronic devices 101. The method may comprise determining a vehicle 210 equipped with an electronic device 101 having a highest correct rate among the correct rates as the preceding vehicle 210.

The method may comprise identifying a communication environment. The method may comprise based on a communication speed according to the communication environment being lower than or equal to a reference communication speed, transmitting, to the external electronic devices 101 through the communication circuitry 211, the first classification result except for the feature map. The method may comprise, based on the communication speed according to the communication environment exceeding the reference communication speed, transmitting, to the external electronic devices 101 through the communication circuitry 211, the feature map and the first classification result.

The method may comprise obtaining, through the communication circuitry 211, width information about a lane of a road on which the vehicle 210 drives. The method may comprise identifying a first pixel count of the width of the lane and a second pixel count in a width direction of the object 270 included in the image 300. The method may comprise identifying, based on a ratio between the first pixel count and the second pixel count and the width information about the lane, a length in the width direction of the object 270.

The method may comprise identifying a class indicated by the plurality of classification results among the first classification result and the second classification result as the class of the object 270.

The above-described method may be performed by an electronic device 105 including a camera 245 and communication circuitry 215. The method may comprise obtaining, through the camera 245, an image 600. The method may comprise identifying, using the another image 600 and the neural network model 400, an area where the preceding vehicle 230 is included in the image 600. The method may comprise transmitting, through the communication circuitry 211, to external electronic devices included in vehicles subsequent to the vehicle 250 equipped with the electronic device 105, remaining areas other than the area in the image 600.

The method may comprise obtaining, from an external electronic device equipped to the leading vehicle through the communication circuitry 215, a feature map. The method may comprise obtaining, using the feature map and the neural network model 400, a classification result of an object 270 related to the feature map. The method may comprise transmitting, to the external electronic device through the communication circuitry 215, the classification result.

As described above, a non-transitory, computer-readable storage medium may store one or more programs. The one or more programs may, when executed by a processor 221 of an electronic device 101 having a camera 241 and communication circuitry 211, cause the electronic device 101 to obtain an image 300 through the camera 241. The instructions may, when executed by the processor 221, cause the electronic device 101 to identify, using the image 300 and the neural network model 400, a first classification result of an object 270 included in the image 300. The instructions may, when executed by the processor 221, cause the electronic device 101 to transmit, through the communication circuitry 211, to external electronic devices included in vehicles 230 and 250 subsequent to a vehicle 210 equipped with the electronic device 101, a feature map of the neural network model 400 based on the image 300. The instructions may, when executed by the processor 221, cause the electronic device 101 to obtain, through the communication circuitry 211, from the external electronic devices 103 and 105, second classification results of the object 270 which are calculated based on the feature map by the external electronic devices 103 and 105. The instructions may, when executed by the processor 221, cause the electronic device 101 to determine, based on the first classification result and the second classification results, whether to drive the vehicle 210 as a preceding vehicle.

As described above, a non-transitory, computer-readable recording medium may store one or more programs. The one or more programs may, when executed by a processor 225 of an electronic device 105 having a camera 245 and communication circuitry 215, cause the electronic device 105 to obtain an image 600 through the camera 245. The instructions may, when executed by the processor 225, cause the electronic device 105 to identify, using the image 600 and a neural network model 400, an area where a preceding vehicle 230 is included in the image 600. The instructions may, when executed by the processor 225, cause the electronic device 105 to transmit, through the communication circuitry 215, to external electronic devices included in vehicles subsequent to a vehicle 250 equipped with the electronic device 105, remaining areas 730 and 735 other than the area 720 in the image 600.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

According to embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

Although specific embodiments of the disclosure have been described above, various changes may be made thereto without departing from the scope of the disclosure.

What is claimed:

1. An electronic device comprising:
a camera;
communication circuitry;
memory storing a neural network model and instructions, and
a processor operably coupled to the camera, the communication circuitry, and the memory,
wherein the instructions, when executed by the processor, cause the electronic device to:
obtain, through the camera, an image;
identify, using the image and the neural network model, a first classification result of an object included in the image;
transmit, through the communication circuitry, to external electronic devices included in vehicles subsequent to a vehicle equipped with the electronic device, a feature map of the neural network model based on the image;
obtain, through the communication circuitry, from the external electronic devices, second classification results of the object which are calculated based on the feature map by the external electronic devices; and
determine, based on the first classification result and the second classification results, whether to drive the vehicle as a preceding vehicle.

2. The electronic device of claim 1,
wherein the instructions, when executed by the processor, cause the electronic device to:
identify, based on the first classification result and the second classification results, whether the first classification result is correct;
based on the first classification result being incorrect, determine that the vehicle drives as a succeeding vehicle; and
based on the first classification result being correct, determine that the vehicle drives as the preceding vehicle.

3. The electronic device of claim 1,
wherein the instructions, when executed by the processor, cause the electronic device to:
identify, based on the first classification result and the second classification results, correct rates of the electronic device and the external electronic devices; and
determine a vehicle equipped with an electronic device having a highest correct rate among the correct rates as the preceding vehicle.

4. The electronic device of claim 1,
wherein the instructions, when executed by the processor, cause the electronic device to:
identify a communication environment;
based on a communication speed according to the communication environment being lower than or equal to a reference communication speed, transmit, to the external electronic devices through the communication circuitry, the first classification result except for the feature map; and
based on the communication speed according to the communication environment exceeding the reference communication speed, transmit, to the external electronic devices through the communication circuitry, the feature map and the first classification result.

5. The electronic device of claim 1,
wherein the instructions, when executed by the processor, cause the electronic device to:
obtain, through the communication circuitry, width information about a lane of a road on which the vehicle drives;
identify a first pixel count of the width of the lane and a second pixel count in a width direction of the object included in the image; and
identify, based on a ratio between the first pixel count and the second pixel count and the width information about the lane, a length in the width direction of the object.

6. The electronic device of claim 1,
wherein the instructions, when executed by the processor, cause the electronic device to:
identify a class indicated by the plurality of classification results among the first classification result and the second classification result as the class of the object.

7. The electronic device of claim 2,
wherein the instructions, when executed by the processor, cause the electronic device to:
while the vehicle drives as the succeeding vehicle according to determining that the vehicle drives as the succeeding vehicle:
obtain, through the camera, another image;
identify, using the another image and the neural network model, an area where another preceding vehicle is included in the image; and
transmit, through the communication circuitry, to external electronic devices included in vehicles subsequent to the vehicle, remaining areas other than the area.

8. The electronic device of claim 7,
wherein the instructions, when executed by the processor, cause the electronic device to:
obtain, from an external electronic device equipped to the another preceding vehicle through the communication circuitry, a feature map;
obtain, using the feature map and the neural network model, a classification result of an object related to the feature map; and
transmit, to the external electronic device through the communication circuitry, the classification result.

9. The electronic device of claim 7,
wherein the instructions, when executed by the processor, cause the electronic device to:
identify, using the image and neural network model, an object in the another image;
identify a possibility of collision between the object and each of vehicles other than the vehicle equipped with the electronic device; and
transmit, through the communication circuitry, information about the identified object to an external electronic device equipped to a first vehicle with the highest possibility of collision among the other vehicles.

10. The electronic device of claim 9,
wherein the instructions, when executed by the processor, cause the electronic device to:
transmit the information about the identified object to external electronic devices equipped to the remaining other vehicles after transmitting the information about the identified object to the external electronic device equipped to the first vehicle through the communication circuitry.

11. A method performed by an electronic device including a camera and communication circuitry, the method comprising:
obtaining, through the camera, an image;
identifying, using the image and a neural network model, a first classification result of an object included in the image;
transmitting, through the communication circuitry, to external electronic devices included in vehicles subsequent to a vehicle equipped with the electronic device, a feature map of the neural network model based on the image;
obtaining, through the communication circuitry, from the external electronic devices, second classification results of the object which are calculated based on the feature map by the external electronic devices; and
determining, based on the first classification result and the second classification results, whether to drive the vehicle as a preceding vehicle.

12. The method of claim 11, comprising:
identifying, based on the first classification result and the second classification results, whether the first classification result is correct;
based on the first classification result being incorrect, determining that the vehicle drives as a succeeding vehicle; and
based on the first classification result being correct, determining that the vehicle drives as the preceding vehicle.

13. The method of claim 11, comprising:
identifying, based on the first classification result and the second classification results, correct rates of the electronic device and the external electronic devices; and
determining a vehicle equipped with an electronic device having a highest correct rate among the correct rates as the preceding vehicle.

14. The method of claim 11, comprising:
identifying a communication environment;
based on a communication speed according to the communication environment being lower than or equal to a reference communication speed, transmitting, to the external electronic devices through the communication circuitry, the first classification result except for the feature map; and
based on the communication speed according to the communication environment exceeding the reference communication speed, transmitting, to the external electronic devices through the communication circuitry, the feature map and the first classification result.

15. The method of claim 11, comprising:
obtaining, through the communication circuitry, width information about a lane of a road on which the vehicle drives;
identifying a first pixel count of the width of the lane and a second pixel count in a width direction of the object included in the image; and
identifying, based on a ratio between the first pixel count and the second pixel count and the width information about the lane, a length in the width direction of the object.

16. The method of claim 11, comprising:
identifying a class indicated by the plurality of classification results among the first classification result and the second classification result as the class of the object.

17. The method of claim 12, comprising:
while the vehicle drives as the succeeding vehicle according to determining that the vehicle drives as the succeeding vehicle:
obtaining, through the camera, another image;
identifying, using the another image and the neural network model, an area where another preceding vehicle is included in the image; and
transmitting, through the communication circuitry, to external electronic devices included in vehicles subsequent to the vehicle, remaining areas other than the area.

18. The method of claim 17, comprising:
obtaining, from an external electronic device equipped to the leading vehicle through the communication circuitry, a feature map;
obtaining, using the feature map and the neural network model, a classification result of an object related to the feature map; and
transmitting, to the external electronic device through the communication circuitry, the classification result.

19. A non-transitory, computer-readable storage medium storing one or more programs, wherein the one or more programs, when executed by a processor of an electronic device including a camera and communication circuitry, cause the electronic device to:
obtain, through the camera, an image;
identify, using the image and the neural network model, a first classification result of an object included in the image;
transmit, through the communication circuitry, to external electronic devices included in vehicles subsequent to a vehicle equipped with the electronic device, a feature map of the neural network model based on the image;
obtain, through the communication circuitry, from the external electronic devices, second classification results of the object which are calculated based on the feature map by the external electronic devices; and
determine, based on the first classification result and the second classification results, whether to drive the vehicle as a preceding vehicle.

20. The non-transitory, computer-readable storage medium of claim 19,
wherein the one or more programs, when executed by the processor, cause the electronic device to:
identify, based on the first classification result and the second classification results, whether the first classification result is correct;
based on the first classification result being incorrect, determine that the vehicle drives as a succeeding vehicle; and
based on the first classification result being correct, determine that the vehicle drives as the preceding vehicle.
